(19) United States
(12) Patent Application Publication
(10) Pub. No.: US 2024/0331006 A1
(43) Pub. Date: Oct. 3, 2024

(54) Real-Time Item Selection Model for Shopper

(71) Applicant: Uber Technologies, Inc., San Francisco, CA (US)

(72) Inventors: Max Vito Di Capua, Walnut Creek, CA (US); Hiroshi Antonio Mendoza, San Francisco, CA (US)

(21) Appl. No.: 18/295,012

(22) Filed: Apr. 3, 2023

(51) Int. Cl. G06Q 30/0601

(52) U.S. Cl. CPC G06Q 30/0631

(57) ABSTRACT

Systems and methods for determining recommended items from a plurality of available items. The system can access request data indicating requested items and user preferences from a user. The method includes obtaining sensor data indicating available items (e.g., available items at a merchant location). The method includes determining, using machine-learned models a recommended item based on the user preferences and the sensor data. The method includes outputting command instructions to update the user interface of a user device display the recommended item.

### FIELD

The present disclosure generally relates to real-time item selection using machine-learned models that are trained to programmatically implement user preferences. More particularly, the present disclosure is directed to using machine-learned models to deterministically identify a recommended item from a plurality of available items.

### BACKGROUND

Food delivery services allow a user to request a service that may be performed by a vehicle or courier. For instance, a user may request, through a grocery delivery service application, a grocery delivery service having a pick-up location, a drop-off location, and items for delivery. A courier may be assigned to perform the grocery delivery service for the user. This may include selecting items from a pick-up location and transporting the items to a drop-off location.

### SUMMARY

Aspects and advantages of embodiments of the present disclosure will be set forth in part in the following description, or may be learned from the description, or may be learned through practice of the embodiments.

In an example aspect, the present disclosure provides an example computer-implemented method. The example method includes accessing, by a mobile user device, data indicative of a requested grocery item, wherein the requested grocery item is included in a delivery request for a user, and wherein the requested grocery item is presented on a user interface of the mobile user device. The example method includes, accessing, by the mobile user device, data indicative of a preference of the user associated with the requested grocery item. The example method includes, obtaining, via one or more sensors of the mobile user device, sensor data indicative of a plurality of grocery items currently available for selection at a merchant location. The example method includes, determining, by the mobile user device and using one or more machine-learned models, a recommended grocery item from the plurality of grocery items currently available at the merchant location for selection based on the data indicative of the preference of the user associated with the requested grocery item. The one or more machine-learned models are trained to: to obtain input data that is based on the preference of the user associated with the requested grocery item and the sensor data indicative of the plurality of grocery items currently available for selection at the merchant location, compute the recommended grocery item from the plurality of grocery items currently available at the merchant location for selection based on the preference of the user, and output data indicative of the recommended grocery item from the plurality of grocery items currently available at the merchant location. The method includes outputting, by the mobile user device and based on a selection of the recommended grocery item for the requested grocery item, a command instruction to generate an updated user interface that indicates the requested grocery item has been addressed.

In some example implementations, the machine-learned models are trained to obtain a previous delivery request for the requested grocery item, wherein the previous delivery request for the requested grocery item indicates a previous preference of the user. In some example implementations, the machine-learned models are trained to determine the preference of the user based on the previous delivery request for the requested grocery item.

In some example implementations, the machine-learned models are trained to compute the recommended grocery item by identifying a grocery item from the plurality of grocery items currently available at the merchant location, wherein the identified grocery item is indicative of an individual or grouping of grocery items. In some example implementations, the machine-learned models are trained to compute the recommended grocery item by analyzing the identified grocery item to determine characteristics, wherein the characteristics are associated with the preference of the user. In some example implementations, the machine-learned models are trained to compute the recommended grocery item by determining the recommended grocery item based on the characteristics of the grocery item.

In some example implementations, the example method includes obtaining, via the one or more sensors of the mobile user device, second sensor data, wherein the second sensor data is indicative of the recommended grocery item. In some example implementations, the example method includes determining, by the mobile user device and using the one or more machine-learned models, the recommended grocery item based on the second sensor data and the preference of the user.

In some example implementations, the example method includes accessing, by the mobile user device, data indicative of the one or more machine-learned models based on a type of the requested grocery item.

In some example implementations, the example method includes accessing, by the mobile user device, data indicative of the one or more machine-learned models based on the user associated with the requested grocery item.

In some example implementations, the one or more machine-learned models are retrained based on feedback data from the user, wherein the feedback data is indicative of a satisfaction of the user with the recommended grocery item.

In some example implementations, the preference of the user associated with the requested grocery item is indicative of at least one of: (i) a ripeness level; or (ii) a fattiness level.

In some example implementations, the example method includes generating, by the mobile user device and based on the selection of the recommended grocery item for the requested grocery item, the updated user interface that indicates the requested grocery item has been addressed.

In some example implementations, the example method includes determining, by the mobile user device, that the requested grocery item is not currently available at the merchant location, wherein the recommended grocery item is a replacement item for the requested grocery item.

In some example implementations, the data indicative of the preference of the user is generated based on user input provided by the user during formation of a delivery request.

In some example implementations, the data indicative of the preference of the user is accessed via a data structure stored in a memory, the data structure storing preference data associated with the user over a plurality of delivery request instances.

In some example implementations, the one or more machine-learned models includes an item detection model and an item recommendation model. In some example implementations, the item detection model is trained to receive the sensor data indicative of the plurality of grocery items currently available for selection at the merchant, and in response to receipt of the sensor data, generate grocery item data comprising at least: (i) a type of the grocery items; and (ii) a quantity of grocery items of the plurality of grocery items. In some implementations, the item recommendation model is trained to receive the grocery item data and the input data based on the preference of the user, and in response to receipt of the grocery item data and input data, determine the recommended grocery item from the plurality of grocery items.

In another example aspect, the present disclosure provides an example computing system. The example computing system includes one or more processors and one or more non-transitory, computer readable medium storing instructions that are executable by the one or more processors to cause the computing system to perform operations. The example operations include accessing data indicative of a requested grocery item, wherein the requested grocery item is included in a delivery request for a user, and wherein the requested grocery item is presented on a user interface of a mobile user device. The example operations include accessing data indicative of a preference of the user associated with the requested grocery item. The example operations include obtaining, via one or more sensors of the mobile user device, sensor data indicative of a plurality of grocery items currently available for selection at a merchant location. The example operations include determining, using one or more machine-learned models, a recommended grocery item from the plurality of grocery items currently available at the merchant location for selection based on the data indicative of the preference of the user associated with the requested grocery item. The one or more machine-learned models are trained to: obtain input data that is based on the preference of the user associated with the requested grocery item and the sensor data indicative of the plurality of grocery items currently available for selection at the merchant location, compute the recommended grocery item from the plurality of grocery items currently available at the merchant location for selection based on the preference of the user, and output data indicative of the recommended grocery item from the plurality of grocery items currently available at the merchant location. The example operations include outputting, based on a selection of the recommended grocery item for the requested grocery item, a command instruction to generate an updated user interface that indicates the requested grocery item has been addressed.

In some examples, the one or more machine-learned models are trained to obtain a previous delivery request for the requested grocery item, wherein the previous delivery request for the requested grocery item indicates a previous preference of the user. In some examples, the one or more machine-learned models are trained to determine the preference of the user based on the previous delivery request for the requested grocery item.

In some examples, the one or more machine-learned models are trained to compute the recommended grocery item by identifying a grocery item from the plurality of grocery items currently available at the merchant location, wherein the identified grocery item is indicative of an individual or grouping of grocery items. In some examples, the one or more machine-learned models are trained to compute the recommended grocery item by analyzing the identified grocery item to determine characteristics, wherein the characteristics are associated with the preference of the user. determining the recommended grocery item based on the characteristics of the grocery item.

In some implementations the example operations further include obtaining, via the one or more sensors of the mobile user device, second sensor data, wherein the second sensor data is indicative of the recommended grocery item. In some implementations the example operations further include determining, using the one or more machine-learned models, the recommended grocery item based on the second sensor data and the preference of the user.

In some implementations the example operations include accessing data indicative of the one or more machine-learned models based on a type of the requested grocery item.

In some implementations the example operations include accessing data indicative of the one or more machine-learned models based on the user associated with the requested grocery item.

In some examples, the one or more machine-learned models are retrained based on feedback data from the user, wherein the feedback data is indicative of a satisfaction of the user with the recommended grocery item.

In another example aspect, the present disclosure provides for one or more example non-transitory computer-readable media storing instructions that are executable to cause one or more processors to perform operations. The example operations include accessing data indicative of a requested grocery item, wherein the requested grocery item is included in a delivery request for a user, and wherein the requested grocery item is presented on a user interface of a mobile user device. The example operations include accessing data indicative of a preference of the user associated with the requested grocery item. The example operations include obtaining, via one or more sensors of the mobile user device, sensor data indicative of a plurality of grocery items currently available for selection at a merchant location. The example operations include determining, using one or more machine-learned models, a recommended grocery item from the plurality of grocery items currently available at the merchant location for selection based on the data indicative of the preference of the user associated with the requested grocery item. The one or more machine-learned models are trained to: obtain input data that is based on the preference of the user associated with the requested grocery item and the sensor data indicative of the plurality of grocery items currently available for selection at the merchant location, compute the recommended grocery item from the plurality of grocery items currently available at the merchant location for selection based on the preference of the user, and output data indicative of the recommended grocery item from the plurality of grocery items currently available at the merchant location. The example operations include outputting, based on a selection of the recommended grocery item for the requested grocery item, a command instruction to generate an updated user interface that indicates the requested grocery item has been addressed.

Other example aspects of the present disclosure are directed to other systems, methods, apparatuses, tangible non-transitory computer-readable media, and devices for performing functions described herein. These and other features, aspects and advantages of various implementations will become better understood with reference to the following description and appended claims. The accompanying drawings, which are incorporated in and constitute a part of this specification, illustrate implementations of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example computing ecosystem according to example aspects of the present disclosure.

FIG. 2 depicts an example data structure of a memory according to example embodiments of the present disclosure.

FIG. 3 depicts an example user interface according to example aspects of the present disclosure.

FIG. 4A-B depicts example user interfaces according to example aspects of the present disclosure.

FIG. 5 depicts a block diagram of an example data processing pipeline according to example aspects of the present disclosure.

FIG. 6 depicts example sensor data according to example aspects of the present disclosure.

FIGS. 7A-B depicts example sensor data segmentation according to example aspects of the present disclosure.

FIG. 7B depicts example sensor data according to example aspects of the present disclosure.

FIG. 8A depicts an example user interface according to example aspects of the present disclosure.

FIG. 8B depicts an example user interface according to example aspects of the present disclosure.

FIG. 9 depicts a flowchart diagram of an example method according to example aspects of the present disclosure.

FIG. 10 depicts a block diagram of example computing system components according to example embodiments of the present disclosure.

### DETAILED DESCRIPTION

Generally, the present disclosure is directed to improvements in delivery item selection using machine-learned models that help programmatically track, forecast, and implement user preferences. For example, a service entity (e.g., food delivery entity) may utilize a pool of couriers to coordinate delivery services (e.g., food delivery) for requesting users. The requesting users may request the delivery of food items and select item preferences from a merchant location (e.g., grocery store, retail store, etc.) through a software application on the requesting user device. The service entity's operations computing system may process the request to match the requesting user to a courier for the requested delivery service through a software application running on the courier user device (e.g., the couriers' mobile phones) as well as a merchant.

A shopper may be used to retrieve the items from the merchant location for the request. The shopper may include the courier, or an individual associated with the merchant (e.g., a designated shopper at a merchant location). The shopper may be associated with a mobile user device (hereinafter “shopper device”). In some implementations, the shopper device may be the courier user device in the event the shopper is the courier. In some implementations, the shopper device may be a user device associated with a designated shopper at the merchant location. According to example aspects of the present disclosure, the shopper device may utilize one or more machine-learned models to determine the requesting user's preferred item selection from the available items at the merchant location in real-time based on the preferences of the requesting user.

For example, the display of the requesting user device may present a plurality of items available at a merchant location that are eligible for the delivery service. The display of the requesting user device may also indicate one or more user preference options associated with the available items. For instance, the requesting user may indicate a preference that a produce item meet a preferred ripeness level by updating an interactive ripeness element (e.g., slider) on the display of the requesting user device. In some example implementations, the requesting user device may suggest a ripeness level based on input from previous delivery requests. The requesting user may also adjust the suggested ripeness level by adjusting the ripeness element on the display of the requesting user device.

The shopper device may determine the requesting user's preferred item selection from the plurality of available items at the merchant location by indicating recommended items on the display of the shopper device. By way of example, the shopper device may obtain requested grocery items (e.g., produce, meat, etc.) and user preference data (e.g., preferred ripeness level) from the operations computing system. The shopper device may utilize sensors (e.g., cameras on a mobile phone) to obtain sensor data indicative of currently available grocery items at the merchant location. The shopper device may use one or more machine-learned models to process the sensor data to determine recommended grocery items from the plurality of available items by identifying the grocery items that meet the preference (e.g., ripeness level) of the requesting user. For example, the shopper device may capture sensor data (e.g., image frames) of a stack of apples, which may be processed by the machine-learned model to help select an apple from the stack based on the user's preferred ripeness of apples. The display of the shopper device may be updated to indicate the recommended grocery item has been selected.

The one or more machine-learned models of the shopper device may be trained to determine characteristics (e.g., ripeness of fruit, fattiness of meat) of available grocery items at a merchant location. For instance, the one or more models may be trained to distinguish between available fruit on display at grocery store. In some example implementations, the shopper device may include one or more machine-learned models based on the type of grocery item. The one or more models may be further trained using feedback from the requesting user indicating whether the recommended grocery items satisfied the preferences (e.g., met the ripeness level) of the requesting user.

The technology of the present disclosure may provide a number of benefits and technical effects. For instance, the technology of the present disclosure may allow a shopper to be presented with user preferences in real-time while selecting requested items. This may include selection of current inventory once the courier reaches a merchant location. As such, the technology may increase the likelihood of the shopper selecting items the requesting user would have selected. Moreover, by generating recommended items real-time, the technology of the present disclosure may improve the accuracy and satisfaction of selected items for food delivery services. This may help to decrease the computing resources (e.g., processing, power, etc.) for repeat or cancelled delivery requests due to low quality item selections while increasing the efficiency of the shopper. Additionally, the technology of the present disclosure can help save the computing resources of the shopper device by reducing the amount of processing, power, and current technology.

Reference now will be made in detail to embodiments, one or more example(s) of which are illustrated in the drawings. Each example is provided by way of explanation of the embodiments, not limitation of the present disclosure. In fact, it will be apparent to those skilled in the art that various modifications and variations may be made to the embodiments without departing from the scope of the present disclosure. For instance, features illustrated or described as part of one embodiment may be used with another embodiment to yield a still further embodiment. Thus, it is intended that aspects of the present disclosure cover such modifications and variations.

For example, the following describes the technology of this disclosure within the context of a mobile shopper device within a grocery store for example purposes only. As described herein, the technology described herein is not limited to a mobile shopper device in grocery stores and may be implemented for or within any location where grocery items are available for purchase and other computing systems.

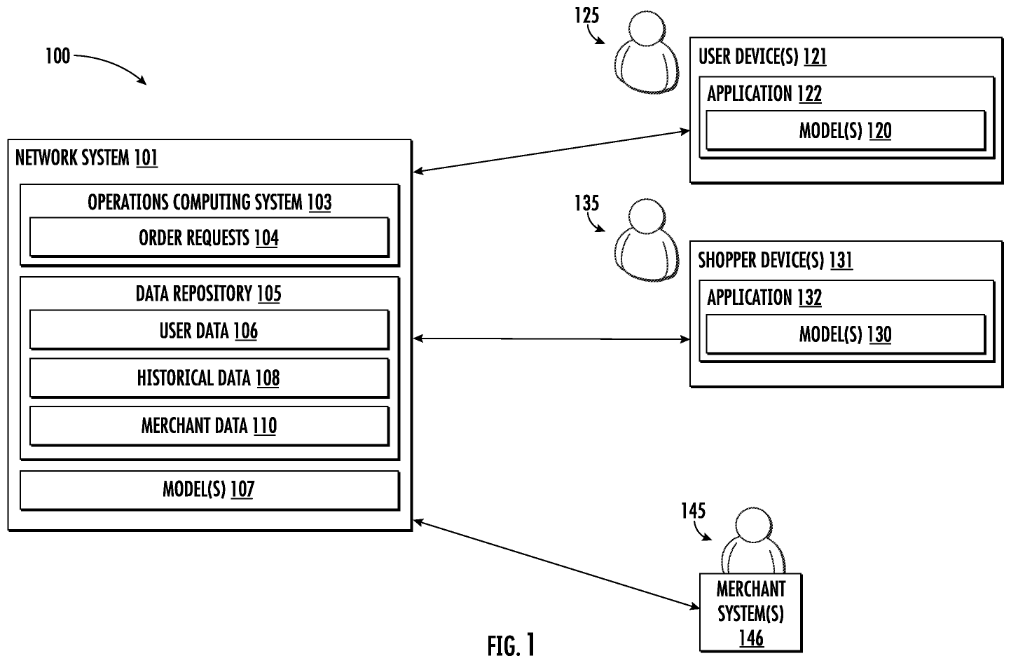

FIG. 1 depicts an example computing ecosystem according to example aspects of the present disclosure. The example system 100 may include a network system 101, one or more users 125 associated with one or more user devices 121, one or more shoppers 135 associated with one or more shopper devices 131, and one or more merchants 145 associated with one or more merchant systems 146. In some examples the one or more merchants 145 may be associated with the shopper devices 131 (e.g., a designated shopper at a merchant location). The example system 100 may facilitate grocery delivery services between the users 125 and the merchants 145 by utilizing shoppers 135 to retrieve requested grocery items from merchant locations associated with the merchants 145.

With respect to examples as described herein, the system 100 may be implemented on a server, on a combination of servers, or on a distributed set of computing devices which communicate over a network such as the Internet. For example, the system 100 may be distributed using one or more servers and/or mobile devices. In other examples, the system 100 is implemented as part of, or in connection with a network system 101, where, for example, operators (e.g., shoppers 135, couriers, etc.) use service vehicles to provide grocery delivery services for requesting users 125. In some examples, the system 100 may be implemented using mobile devices of users (e.g., user devices 121, shopper devices 131) associated with users 125, shoppers 135 and merchants 145 with the individual devices executing a corresponding service application (e.g., application 122, application 132) that causes the computing device to operate as an information inlet and/or outlet for the network system 101. In other examples, the system 100 may be implemented using one or more merchant systems 146 associated with one or more merchants 145. The merchant system 146 may operate as an information inlet and/or outlet for the system 100 to exchange data with the network system 101.

The network system 101 may include a number of subsystems and components for performing various operations. For example, the network system 101 may include an operations computing system 103, data repository 105, and one or more machine-learned models 107. The network system 101 may be any computing device that is capable of exchanging data and sharing resources. For example, the network system 101 may include one or more networked devices configured to store or transmit data over physical or wireless technologies. In some examples, the network system 101 may include hardware and software. In other examples, the network system 101 may include physical equipment that is connected to a physical network.

The network system 101 may include an operations computing system 103. In some examples, the operations computing system 103 may be implemented by one or more computing devices. For example, the operations computing system 103 may include one or more processors and one or more memory devices. The one or more memory devices may store instructions executable by the one or more processors to cause the one or more processors to perform operations or functions associated with other subsystems or components of the network system 101.

In some examples, the operations computing system 103 may include an order request subsystem 104 configured to receive order requests from users 125 for grocery delivery services. For example, a user 125 may submit a grocery delivery service order request through an application 122 running on the user device 121 associated with the user 125. In some examples, the order request subsystem 104 may receive a single grocery delivery service order request from a user 125. In some examples, the order request subsystem 104, may receive multiple grocery delivery service order requests from multiple users 125 concurrently. In some examples, the order request subsystem 104 may coordinate multiple grocery delivery service order requests from the same user 125 which require selection or delivery of grocery items from multiple merchant locations.

The order request subsystem 104 may perform actions to coordinate a completion time of an order request, with an estimated time of arrival for requested items. In some examples, where the merchant 145 or an individual associated with the merchant 145 is associated with the shopper device 131, the order request subsystem 104 may coordinate actions to ensure a courier (e.g., individual delivering items to user 125) does not have to wait an extended period of time at the merchant location for the merchant 145 to prepare the order request. In other examples, the order request subsystem 104 may determine if there are insufficient resources to complete the grocery delivery service order request. For example, insufficient resources may indicate there are no available couriers to deliver the requested grocery items. In some examples, the order request subsystem 104 may reject a grocery delivery service order request if there are insufficient resources (e.g., shoppers 135, couriers, etc.) to complete the grocery delivery order request. In other examples, the order request subsystem 104 may offer alternative solutions (e.g., a later time or day) if there are insufficient resources to complete the grocery delivery order request.

In some examples, the order request subsystem 104 may provide data indicative of the grocery delivery service request to other subsystems and components of the network system 101 for further processing or storage. For instance, the order request subsystem 104 may provide the data indicative of the grocery delivery service request to the data repository 105. The data repository 105 may include, for example, data stores such as relational databases, non-relational databases, key-value stores, full-text search engines, message queues, etc.

The data repository 105 may include user data 106, historical data 108, and merchant data 110. Such data may be encrypted, stored in a secure manner, pseudonymized, or optionally collected (e.g., as selected by a user 125). In some examples, the data repository 105 may be replicated to ensure the data stored in the data repository 105 is readily available for the plurality of user devices 121, shopper devices 131 and merchant systems 146.

User data 106 may include data associated with users 125 of the grocery delivery service entity. In some examples, user data 106 may include user profile information (e.g., name, address, payment information) and user preferences (e.g., ripeness level of produce grocery items) of users 125.

Historical data 108 may include historical information associated with users 125 or merchants 146. For example, historical data 108 may include a previous grocery delivery service order requests that indicate items, merchant locations, and feedback from a user 125. In some examples, historical data 108 may include the history of specific grocery item availability at a merchant location, completion time to prepare an order, etc.

In some examples, the data repository 105 may be updated by user devices 121. shopper devices 131, and merchant systems 146. For example, as users 125 submits, via the application 122 running on the user device 121, a grocery delivery service order request, the data repository 105 may updated to reflect the grocery delivery service request. In some examples, the shopper device 131 may update, via the application 132 running on the shopper device 131, the data repository 105 by providing updates (e.g., item unavailable, shopping complete, etc.) associated with the delivery service order request. In other examples, the merchant systems 146 may update the data repository 105 to reflect changes such as inventory levels at merchant locations, operating hours of merchant locations, etc. In some examples, the data repository 105 may be updated dynamically (e.g., as events occur) or may be updated on a scheduled reoccurring basis.

In some examples, one or more machine-learned models 107 may utilize the data stored in the data repository 105. By way of example, the one or more models 107 may be or may otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks. For example, the one or more models 107 may obtain user data 106 including user preferences, historical data 108 including previously requested grocery items, and merchant data 110, to determine a user preference suggestion for grocery items of a current delivery service order request. In some examples, the one or more models 107 may include a user preference model trained to determine the preferences of a user 125.

As indicated, the system 100 may include various users 125 and user devices 125. Users 125 may include individuals, or a group of individuals associated with a user profile configured to interact with a grocery delivery service entity. In some examples, users 125 may utilize a guest profile (e.g., one time use) to interact with the grocery delivery service entity. The user device 121 may include a mobile computing device, such as a smartphone, tablet computer, laptop computer, VR or AR headset device, and the like. As such, the user device 121 may include components such as a microphone, a camera, a satellite receiver, and a communication interface to communicate with external entities using any number of wireless communication protocols. In some examples, the user device 121 may store a designated service application (e.g., application 122) in a local memory. In some examples, the memory may store additional applications executable by one or more processors of the user device 121, enabling access and interaction with one or more host servers over one or more networks. In some examples, user devices 121 may communicate with the network system 101 over one or more networks.

User devices 121 may be associated with users 125 and allow the user 125 to interact with the grocery delivery service entity (e.g., network system 101). For example, in response to user input by a user 125, the application 122 may interact with the user device 121 to display an application interface on a user interface of the user device 121. In some examples, the user 125 may select items and submit a grocery delivery service order request through the application 122 running on user device 121. In some examples, the user 125 may view order updates (e.g., order in progress, complete, unavailable items, etc.) on the user interface of the user device. In some examples, the user 125 may view an ETA (estimated time of arrival) for the order request.

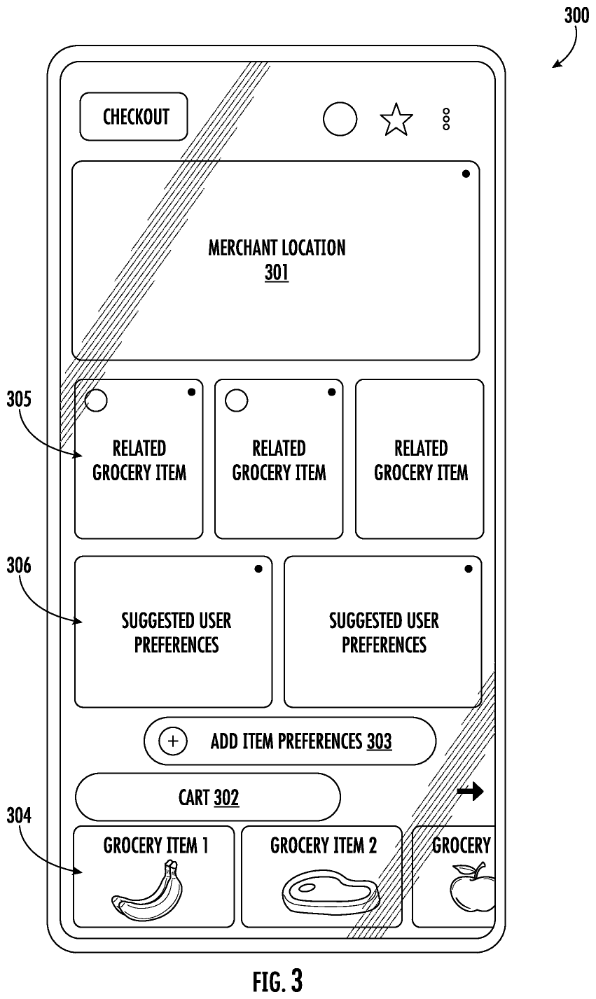

In some examples, the user device 121 may receive data from the network system 101. For example, the application 122 may receive data stored in the data repository 105 of the network system 101. In some examples, the application 122 may interact with the user device 121 to display historical data 108 (e.g., a user's order history). In some examples, the application 122 may interact with the user device 121 to display merchant data 110 (e.g., available grocery items available at a merchant location). In other examples, the application 122 may interact with the user device 121 to display suggestions for grocery items that are likely to be desired by the user 125. For example, the one or more models 107 may include a user preference model trained to determine the preferences of a user 125. For example, the user preference model, may utilize user data 106 containing user preference selections and historical data 108 containing an order history of the user 125 to determine the preferences of the user 125 for a current order request. In some examples, the application 122 may interact with the user device 121 to display the suggested grocery items determined by the one or more models 107 of the network system 101. For example, the one or more models may include a suggested item model trained to determine suggested items based on data stored in the data repository 105. In other examples, the application 122 may interact with the user device 121 to display suggested user preferences for currently selected items (e.g., items in the user's cart) prior to the user submitting the order request. An example user interface is further described with reference to FIG. 3.

In some examples, the user device 121 may transmit preference data to the network system 101. For example, the application 122 may interact with the user interface of the user device 121 to display selectable options for the user 125. For example, the application 122 may interact with the user device 121 to display user preference options. In some examples, the user 125 may indicate a preference that produce, or meat grocery items meet a preferred ripeness or fattiness level by interacting with (e.g., adjusting, sliding, swiping, typing, etc.) an interactive ripeness element (e.g., slider, menu) on the display of the user device 121. In some examples, the user 125 may indicate (e.g., prior to submitting an order request) that user preferences should be used for all future order requests. For example, the user 125 may indicate (e.g., prior to submitting an order request) that user preferences should only be used for a current order request. For instance, the application 122 may interact with the user device 121 to display user preference options and the user 125 may select a user interface element to indicate that user preference selections are only for the current order request. In other examples, the user 125 may opt to not save the user preference selections.

In other examples, the user 125 may update previously saved user preferences. For example, the application 122 may interact with the user interface of the user device 121 to display saved user preference options. The user 125 may indicate updated user preferences by updating an item preference user interface element. For example, the user 125 may indicate an updated user preference that produce, or meat grocery items meet a preferred ripeness or fattiness level by interacting with (e.g., adjusting, sliding, swiping, typing, etc.) an interactive ripeness element (e.g., slider, menu) on the display of the user device 121. The item preference user interface element is further described with reference to FIG. 3.

In some examples, user data 106 may include user preferences. The user preference selections may be transmitted over one or more networks and stored in a data repository 105 of the network system 101. In some examples, the user preference selections may be used as input data to the one or more models 107 of the network system 101.

In some examples, the user device 121 may transmit feedback data to the network system 101. For example, the application 122 may interact with the user device 121 to display a feedback element on the user interface of the user device 121. The user 125 may provide feedback indicating satisfaction or dissatisfaction with the grocery delivery service. In some examples, the user 125 may indicate feedback associated with user preferences.

For example, the application 122 may interact with the user interface of the user device 121 to display a feedback user interface element. In some examples, the feedback user interface element may be displayed after the user 125 has received the requested grocery items. For example, the user 125 may indicate that a specified item preference (e.g., a produce ripeness level) was satisfied by providing a rating (e.g., rating on a rating scale or text via a rich text editor, etc.). In some examples, the user 125 may indicate that a specific item preference was not satisfied by providing a rating (e.g., rating on a rating scale or text via a rich text editor, etc.). In some examples user data 106 may include feedback data captured by the feedback user interface element. In other examples, historical data 108 may include feedback data captured by the feedback user interface element. The user feedback data may be captured by the feedback user interface element via the display of the user device 121 and transmitted to the network system 101 and stored in the data repository 105. In some examples, the user feedback data may be used to train the models 107 of the network system 101.

The system 100 may include shoppers 135 and shopper devices 135. A shopper 135 may be used to retrieve requested grocery items from a merchant location. In some examples, the shopper 135 may include the courier (e.g., individual transporting requested grocery items), or an individual associated with the merchant 145 (e.g., a designated shopper at a merchant location). The shopper device 131 may include a mobile computing device, such as a smartphone, tablet computer, laptop computer, VR or AR headset device, and the like. As such, the shopper device 131 may include features such as a microphone, a camera, a satellite receiver, and a communication interface to communicate with external entities using any number of wireless communication protocols.

In some implementations, the shopper device 131 may be a courier device via which a courier receives data associated with the delivery service request. This may include instructions for traveling to a merchant location associated with one or more merchants 145, items selected by a user 125, etc.

In some implementations, the shopper device 131 may be a mobile computing device associated with a merchant location. This may include a dedicated tablet, phone, etc. that is utilized by a shopper 135 within the merchant location. The shopper device 131 may receive, for a merchant 145, data that is associated with the delivery service order request. This may include items selected by a user 125, pick-up times, etc. In some implementations, a shopper device 131 may be communicatively connected to a computing system of the merchant location (e.g., inventory systems, POS systems, etc.).

In some examples, the shopper device 131 may store a designated service application (e.g., application 132) in a local memory. In some examples, the memory may store additional applications executable by one or more processors of the shopper device 131. enabling access and interaction with one or more host servers over one or more networks. In some examples, shopper devices 131 may communicate with the network system 101 over one or more networks.

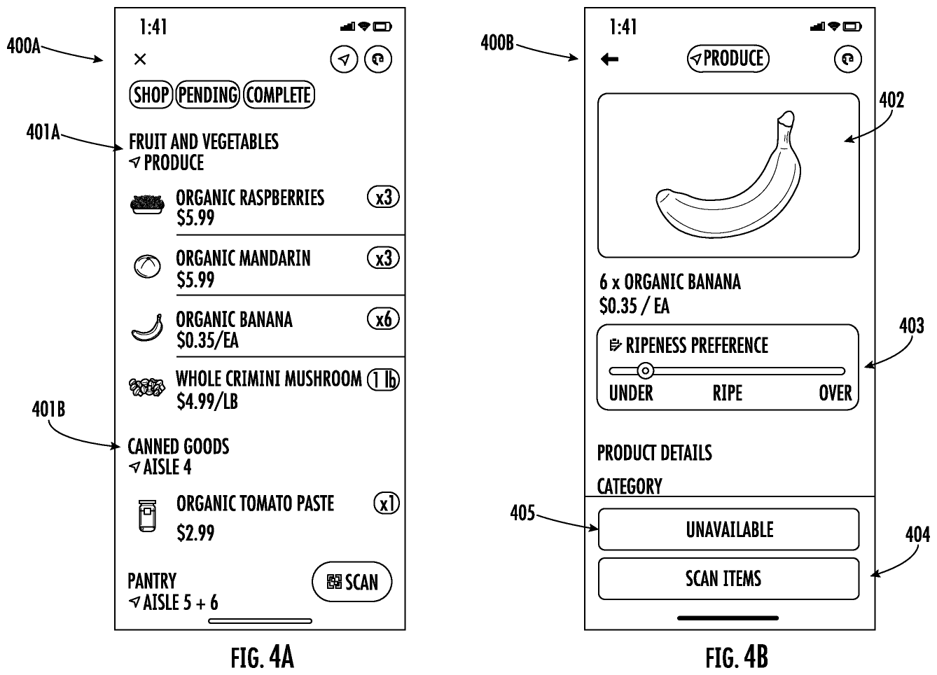

Shopper devices 131 may be associated with shoppers 135 and allow the shopper 135 to interact with the grocery delivery service entity. For example, in response to user input by a shopper 135, an application 132 may interact with the shopper device 131 to display an application interface on a user interface of the shopper device 131. An example user interface of a shopper device is further described with reference to FIGS. 4A-4B.

In some examples, the shopper device 131 may receive, over one or more networks, data from the network system 101. For example, the application 132 may receive data stored in the data repository 105. In some examples, the application 132 may interact with the shopper device 131 to display merchant data 110 (e.g., merchant location, item locations within merchant location, etc.). In other examples, the application 132 may interact with the shopper device 131 to display user data 106 (e.g., user preferences, essential items, etc.).

The shopper device 135 may include one or more machine-learned models 130 configured to improve the grocery item selections for the requested grocery items. As examples, the one or more models 130 may be or may otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks. For example, the one or more models 107 may obtain user data 106 including user preferences, historical data 108 including previously requested grocery items, and merchant data 110, to determine a user preference suggestion for grocery items of a current delivery service order request.

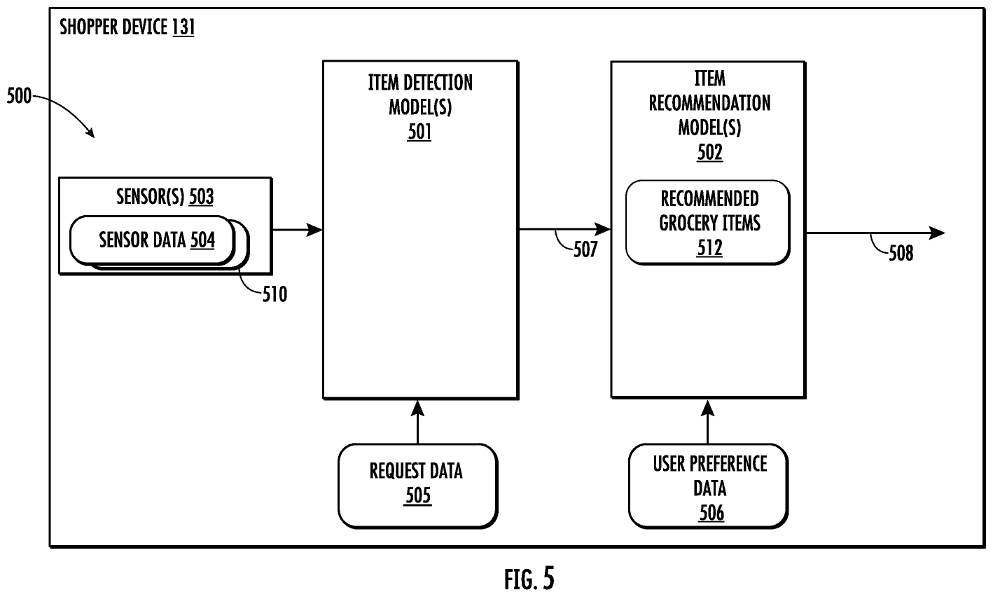

In some examples, the one or more models 130 may include an item detection model trained to detect grocery items available at a merchant location. In some examples, the one or models 130 may include an item recommendation model trained to determine a recommended grocery item from the available grocery items at a merchant location. In some examples, the item detection and item recommendation models may be trained to utilize data from the data repository 105. For example, the historical data 108 (e.g., previously requested grocery items) and user data 106 (e.g., user preference data, user feedback, etc.) may be input to the one or more models 130 to improve the grocery item selections for the requested grocery items. Examples of the one or more machine-learned models 130 are further described with reference to FIG. 5.

In some examples, the shopper device 131 may transmit data to the network system 101. For example, the application 132 may interact with the user interface of the shopper device 131 to display user preference selections of the user 125. In some examples, the shopper device 135 may indicate that a produce or meat grocery items meet a preferred ripeness or fattiness level and determine a recommended grocery item. In some examples, the shopper device 131 may transmit output indicative of the recommended grocery item to the network system 101 where the output may be stored in the data repository 105 of the network system 101. In some examples, the output indicative of the recommended grocery item may be accessible by the user device 121. For example, the user interface of the user device 121 may display the output indicative of the recommended grocery item (e.g., image of the selected item including the available items) as an update to the order request that the item was selected (e.g., shopped) by the shopper 135. In some examples, the user interface of the user device 121 may display the output indicative of the recommended grocery item after the grocery items have been delivered to solicit feedback from the user 125. Example shopper user interfaces including user feedback are further described with reference to FIGS. 4A-4B.

In some examples, the shopper device 131 may transmit data to the network system 101. For example, the application 132 may interact with the user device 121 to indicate updates associated with the order request. For example, the shopper 135 may provide updates indicating that a requested grocery item has been addressed (e.g., item was available and selected by the shopper). In some examples, the shopper 135 may provide updates indicating that a requested grocery item is unavailable (e.g., out of stock). In other examples, the shopper 135 may provide updates indicating that none of the available grocery items meets the user preferences (e.g., ripeness level of produce). The updates associated with the order request may be transmitted over one or more networks and stored in a data repository 105 of the network system 101. In some examples, the updates may be used to train the models 107 of the network system 101.

The system 100 may include merchants 145 and merchant systems 146 that operate as an information inlet and/or outlet for the system 100 to exchange data with the network system 101. Merchants 145 may include any person or company involved in the trade or sale of items (e.g., grocery items). Merchants 145 may be associated with merchant locations (e.g., physical locations, grocery stores, etc.) where grocery items may be purchased. Example merchant locations include conventional supermarkets, limited assortment supermarkets, supercenters, warehouse clubs, or convenient stores. In some examples, merchants 145 may be associated with shopper devices 131. For example, merchants 145 may offer merchant shopper services (e.g., a designated shopper at a merchant location) to select grocery items requested using the grocery delivery service entity. In some examples, merchants 145 associated with a shopper device 131 may perform similar operations as a shopper 135 as described herein.

Merchant systems 146 may be associated with one or more merchants 145. Merchant systems 146 may include a record for each merchant 145 subscribed to the grocery delivery service entity as well as associated merchant locations. By way of example, the merchant systems 146 may aggregate inventory data for each respective merchant location to define grocery items that are available at each merchant location associated with the respective merchants 145. In some examples, the merchant systems 146 may include the location of grocery items that are available within each specific merchant location. The merchant systems 146 may be updated by merchant 145 to reflect the most up to date inventory levels at the respective merchant locations associated with the merchants 145. In some examples, the merchant systems 146 may synchronize within inventory management software, point-of-sale systems, etc. of one or more merchants 145 to maintain accurate levels of inventory at each respective merchant location.

In some examples, merchant systems 146 may transmit merchant data 110 to the network system 101. For example, a merchant system 146 may be updated (e.g., by an individual associated with the merchant 145, automatically, etc.) to indicate that a particular item is no longer available at a merchant location associated with the merchant 145. In some examples, a merchant system 146 may be updated to indicate that previously unavailable grocery items are now available at a merchant location associated with the merchant 145. The merchant system 146 may transmit updated merchant data 110 indicating the change in inventory to the network system 101. In some examples, the network system 101 may utilize the updated merchant data 110 for processing order requests from users 125 of the grocery delivery service entity.

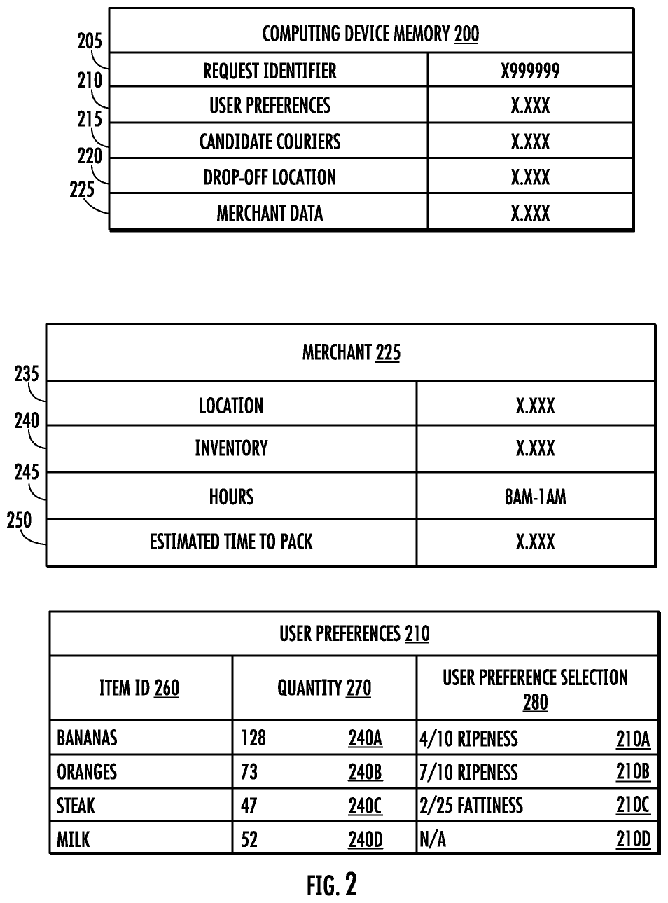

As described herein, the network system 101 may include a data repository 105. An example of a data structure that may be stored in or associated with the data repository 105 is described with reference to FIG. 2.

FIG. 2 depicts an example data structure of a memory according to example embodiments of the present disclosure. Example data may include request identifiers 205, user preferences 210, candidate couriers 215, drop-off location 220, or merchant data 225. Merchant data 225 may include data associated with one or more merchants 145.

Request identifiers 205 may be an identifier associated with the grocery delivery service request. Request identifiers 205 may be associated with an order request. An order request may include a plurality of items in an order request. For instance, the network system 101 may obtain data indicative of an order request including a request for at least a first grocery item (e.g., item identifier bananas) and a second grocery item (e.g., item identifier steak) to be transported to a destination location (e.g., drop-off location 220). A request identifier can be assigned by the network system 101 to the order request and item identifiers can be assigned therein (e.g., using look-up tables, etc.).

In some examples, request identifiers 205 may be systematically assigned using alpha numerical generators that assign request identifiers 205 to the order request. In some examples, the order request subsystem 104 may generate the request identifiers 205 upon receiving the order request for the user device 121. In some examples, the request identifiers 205 may indicate an order in which the order requests were received by the order request subsystem 104. For instance, request identifiers 205 including lower integers may be generated and assigned to order requests received before request identifiers 205 including higher integers. In other examples, the request identifiers 205 may indicate a total count of order received by the order request subsystem 104.

User preferences 210 may include preferences associated with the user 125 indicative of the ripeness (e.g., of produce), the fattiness (e.g., of meats, dairy), expiration dates, origin (e.g., Ecuadorian coffee or produce), color, or any other data associated with a user preference (e.g., as depicted in 210A-D). The user preferences 210 may be accessed based on metadata included in the order request such as an encrypted identifier associated with the user 125 that allows the operations computing system 103 to access data for the particular user 125 (e.g., from stored user profile). In some examples, user preferences 210 may be generated by models 107 of the network system 101 based on data stored in the data repository 105. In some examples, user preferences may be generated from user 125 via the user device 121 when the user is creating the order request. An example of user preferences being selected via user device 121 is further described with reference to FIG. 3.

Candidate couriers 215 may include data indicative of a plurality of candidate couriers available to facilitate completion of one or more current or future grocery delivery service requests. For instance, candidate couriers 215 may include data associated with a current number of active couriers within a geographic area. In some examples, active couriers may be determined by determining the application 132 of a courier device (e.g., shopper device 131) indicates an active state. Candidate couriers 215 may include information about each respective courier. For instance, candidate couriers 215 may include data indicative of preferences of respective couriers, location of respective couriers, etc. In some examples, candidate couriers 215 may include shoppers 135. In some examples, the shopper 135 and candidate courier 215 may be separate individuals. For example, a designated shopper 135 at a merchant location where the requested grocery items are located may retrieve the requested grocery items, and a candidate courier 215 may transport the retrieved grocery items to a drop-off location 220. The drop-off location 220 may include data indicative of a destination location for the requested grocery items associated with the grocery delivery service order request to be dropped off by one or more couriers.

By way of example, a current number of active couriers within a geographic area may be compared to a threshold number of active couriers within a geographic area. For instance, a threshold number of active couriers may be indicative of a number of couriers being active in a geographic area to adequately perform a plurality of current or predicted future vehicle service requests. A number of active couriers that exceeds the threshold number of active couriers may be indicative of a surplus of available couriers to perform expected vehicle service requests within the geographic region. A number of active couriers that does not exceed the threshold number of active couriers may be indicative of an undersupply (e.g., insufficient resources) of active couriers in a geographic area to perform expected grocery service delivery requests within the geographic region.

Merchant data 225 may include data associated with a plurality of merchants (e.g., merchants 145). For instance, merchant data 225 may include a location 235 of a merchant 145, inventory 240 of grocery items offered by the merchant 145, hours 245 of operation of the merchant 145, an estimated time to pack 250 grocery items at the merchant location or other information. Location data 235 may include data indicative of a location of the merchant (e.g., geographic location, GPS coordinates, latitude and longitude). Inventory 240 may include a listing of item identifiers (e.g., item ids) and the quantity of grocery items (e.g., as depicted in 240A-D). Estimated time to pack 250 may include an average time it takes to pack the grocery item (e.g., for a shopper 135, merchant 146, or courier to obtain the item and check out at a merchant location). Estimated time to pack 250 may include a time to physically find an item. Estimated time to pack 250 may vary for item ids 260 based on each merchant 145. For instance, in some merchant locations, produce may be located right near the entrance, whereas in alternative merchant locations, produce is located in the back of the store. Thus, the estimated time to pack 250 may be indicative of an average time to pack determined by the computing system (e.g., system 100, network system 101, or operations computing system 103).

Upon receiving an order request, the network system 101 may concatenate the data stored in memory 200. For instance, user preferences 210 may be concatenated to correlate item id 260 of requested grocery items with a quantity 270 of each item at a merchant location and the user preferences selection 280. The item id 260 may include the name of the requested grocery item. The quantity may include an integer totaling the number of available items matching the item id 260 at a merchant location. The user preferences selection 280 may include an integer, fraction, percentage, or any other identifier on a pre-determined scale.

As depicted in FIG. 2, a user 125 may submit an order request for bananas, oranges, steak, and milk. The bananas, oranges, steak, and milk may each include an item id 260 indicating the name of each respective item. The item id 260 may be associated with a merchant 145 that includes sufficient inventory 240 of item ids 260 that match bananas, oranges, steak, and milk. The item id 260 may be associated with a quantity 270 of each respective item id 260 (e.g., 240A-D). In an example, the network system 101 may determine that a first item and second item (e.g., item id banana 260A based on inventory 240A or item id oranges 260B based on inventory 240B) is available at a merchant location (e.g., merchant 145). In some examples, the network system 101 may determine that a third item (e.g., item id steak 260C based on inventory 240C) has low stock and a fourth item (e.g., item id milk 260D based on inventory 240D) is unavailable (e.g., out of stock) at a merchant location (e.g., merchant 145).

The network system 101 may concatenate the user's 125 user preferences selection 280 for each of the item ids 260. For example, a user 125 may indicate a ripeness of oranges 210B. The ripeness of oranges 210B may be associated with the item id oranges 260B and the quantity of oranges 240B. In some examples, a user 125 may not indicate a user preferences selection 280 for a requested item. For example, the user preferences selection 280 may indicate a null value (e.g., no user preferences are applicable, 210D) for the item id milk 260D. In some examples, where a user 125 does not indicate a user preferences selection, the shopper 135 may select any of the available grocery items at the merchant location. In some examples, the user 125 may indicate a user preferences selection 280 for future order requests. In other examples, the network system 101 may suggest, using models 107 a user preferences selection 280. For instance, models 107 may determine a suggested user preferences selection 280 based on feedback from the user 125 from pervious order requests. Example determination of suggested user preference selections 280 is further described with reference to FIG. 3.

FIG. 3 depicts an example user interface according to example aspects of the present disclosure. By way of example, the user interface 300 may be a user interface of a user device 121 associated with a user 125 to allow the user 125 to interact with a grocery delivery service entity. For example, the application 122 may interact with the user device 121 to display on the user interface 300 an application interface. The application 122 may cause the user interface 300 to render the user interface 300 via a display device (e.g., screen).

In some examples, the user interface 300 may include one or more interactive user interface elements. The user interface elements may be selectable, adjustable, or otherwise interactive. For instance, interaction with the user interface elements may allow a user 125 to submit an order request for grocery items as well as submit other related information. By way example, the user interface 300 may include one or more merchant location elements 301. cart elements 302, an add item preferences elements 303, a grocery item elements, a related grocery item element 305, and a suggested user preference element 306. The interactive user interface elements may each be selectable, adjustable, or interactive. Example types of interactive elements may include soft buttons, menus, checkboxes, sliders, etc.

The merchant location element 301 may include a user interface element that allows a requesting user (e.g., user 125) to select one or more merchant locations where grocery items are available. For example, a requesting user 125 may search for apples and select a merchant location 301 that has available apples. In some examples, the merchant location 301 may indicate a plurality of merchant locations 301. For example, a requesting user 125 may search for bananas and apples and select a first merchant location 301 that includes apples and a second merchant location 301 that includes bananas. In some examples, a requesting user 125 may search for a specific merchant location 301 and add grocery items to the cart 302 that are available at the specific merchant location 301. In some examples, the merchant location 301 may include merchant locations 301 that are in a relative geographic vicinity to the requesting user 125.

The cart element 302 may include a user interface element that allows a user 125 to identify items that have been added to the order request. For example, as depicted in example user interface 300, the cart element 302 may include one or more grocery items user interface element such as bananas, meat, and apples that have been added to the order request (e.g., cart 302). In some examples, the cart 302 may be an interactive user interface element. For example, a requesting user 125 may interact with the cart 302 to remove one or more grocery items (e.g., depicted within the grocery item user interface elements) that have been added to the order request. In some examples, the cart 302 may store one or more grocery items to be ordered by the requesting user 125 at a later time. In some examples, the cart 302 may be automatically updated to reflect changes in the availability of grocery items. For example, the grocery items user interface element 30 may be updated to reflect out of stock grocery items. For instance, a requesting user 125 may add a banana grocery item to the cart 302. In some examples, the user device 121 may determine that the banana grocery item is no longer available (e.g., out of stock) at a merchant location 301 and automatically update the cart 302 user interface element to reflect the change in availability. In some examples, the merchant system 146 may provide updated merchant data 110 to the network system 101 indicating that bananas are unavailable (e.g., out of stock) at the merchant location. In other examples, the cart 302 (or another portion of the user interface 300) may indicate that unavailable grocery items at a first merchant location are available at a second merchant location. For example, the merchant location element 301, grocery item element, or the cart 302 may be updated to reflect the alternative location of the grocery items added to the order request.

The user interface 300 may display one or more related grocery item elements 305 based on the items present in the cart 302. For example, as depicted in example user interface 300 a user 125 may add a meat grocery item to the cart 302. In some examples, the user interface 300 may display a related grocery item element 305 indicating related grocery items such as potatoes based on the meat grocery items in the cart 302. For instance, a related grocery item 305 may complement the grocery items in the cart 302.

In some examples, the models 107 of the network system 101 may be used to determine related grocery items 306 based grocery items present in the cart 302. For example, models 107 may utilize user data 106, historical data 108, and merchant data 110 of the network system 101 to determine the relationship of a grocery items in the cart 302 to a related grocery item 305. In other examples, historical data 108 of the network system 101 may be used to determine related grocery items 305 based on grocery items present in the cart 302. For example, historical data 108 may indicate that one or more requesting users 125 have added a related grocery item 305 to the cart 302 after adding specific grocery items to the cart 302 in previous order requests. Related grocery items 305 may be based on other inputs such as historical trends (e.g., items commonly bough together), the geographic region of the merchant location 301 or requesting user 125, or any other factors.

In some implementations, the user interface 300 may display an option to add item preferences to one or more grocery items in the cart 302. The add item preferences element 303 may include one or more user preference selections 280 for selected grocery items for the requesting user 125. The user 125 may interact (e.g., click) with the add item preferences element 303 to provide user input indicative of user preference selections 280. For example, add item preferences element 303 may include ripeness (e.g., of produce), the fattiness (e.g., of meats, dairy), expiration dates, origin (e.g., Ecuadorian coffee or produce), color, or any other data associated with a user preferences. For instance, a user 125 may add a banana grocery item and a meat grocery item to the cart 302 and interact with the add item preferences element 303 to provide user preference selections 280 (e.g., a ripeness level, fattiness level, etc.) for the banana grocery item and the meat grocery item. For example, the application 122 may cause the user interface 300 to render the user interface to display an interactive slider user interface element. The interactive slider user interface element may allow the user 125 to slide a slider on a slider scale to indicate a user preference (e.g., level of ripeness) for a grocery item. In some examples, the interactive user interface element may include a graphic rating scale, numerical rating scale, descriptive rating scale, comparative rating scale or any form of rating scale that allows for consistent rating input that captures the preferences of the user 125. The input provided by the user 125 may be stored as user preference selections 280 and utilized by the network system 101 or shopper device 131.

In some examples, add item preferences element 303 may be selected only for a current order request. For example, a user 125 may add grocery items to the cart 302 and indicate a one-time user preference selection 280 by selecting the add item preferences element 303 user interface element and indicating the item preference is only to be used one time for the current order request (e.g., single use user preference selections 280). In some examples, item preferences 303 may be preselected and saved by the requesting user 125 for future orders. For instance, a user 125 may add grocery items to the cart 302 and indicate permanent item preferences by selecting the add item preferences element 303 user interface element and interacting (e.g., click) with a save user interface element to save the preferences. In some examples, the saved preferences are stored as user preference selections 280. Saved item preferences may indicate that each time a steak grocery item is added to the cart 302, the user preference selections 280 for steak should apply. In some examples, user preference selections 280 may be stored within user data 106 and may be transmitted to the data repository 105 of the network system 101. In some examples, the user preference selections 280 may be stored within the computing device memory 200. In other examples, the user preference selections 280 may be transmitted from the data repository 105 of the network system 101 to a shopper device 131. For instance, a shopper 135 may access the user preference selections 280 captured by the add user preferences element 303 from the user 125 to determine a recommended item from a plurality of available items at a merchant location 301 based on the user preference selections 280.

User preference selections 280 captured by the add user preferences element 303 may be used by the computing system 100 to ensure that items selected by a shopper 135 meet the user preference selections 280 selected by the user 125. For example, user preference selections may be included in user data 106. A shopper device (e.g., shopper device 131) may access user data 106 while the shopper 135 is selecting grocery items requested by the user 125 at the merchant location 301. For example, the application 132 may receive data stored in the data repository 105 (e.g., based on a transmitted request, a push from the network system 101, etc.). In some examples, the application 132 may interact with the shopper device 131 to display merchant data 110 (e.g., merchant location, item locations within merchant location, etc.). In other examples, the application 132 may interact with the shopper device 131 to display user data 106 (e.g., user preference selections 280, essential items, etc.). In some examples, item preferences may be used to ensure that a shopper 135 does not select items that do not meet the user preference selections 280 captured by the add user preferences element 303 from the user 125. Utilization of item preferences by a shopper device 131 is further described with reference to FIG. 5.

In some examples, the add item preferences element 303 may be updated by the model 107 of the network system 101. For example, the models 107 of the network system 101 may include a user preference model trained to determine the user preference selections 280 of a user 125 by utilizing feedback from the user 125. For instance, a user 125 may indicate user preference selections 280 for a grocery item on a previous order request and provide feedback that the requested grocery items did not meet the user preference selections 280 captured by the add user preferences element 303. In some examples, the one or more models 107 of the network system 101 may determine an updated item preference by utilizing the user data 106 including user preferences data 210. As described herein, the user preferences data 210 may indicate the user preference selections 280 captured by the add user preferences element 303 of the previous order request and the feedback of the user 125. The updated user preference selections 280 may compensate for any misalignment of the user preferences data 210 and the user preference selections 280 captured by the add user preferences element 303. In some examples, the feedback of the user 125 may be used to further train the one or models 107.

The one or models 107 of the network system 101 may include a user preferences machine-learned model configured to determine the preferences of the user 125. For example, the one or more models 107 may determine a threshold number of orders is met to determine the preferences of the user 125.

The user interface 300 may display one or more suggested user preference elements 306 based on the grocery items in the cart 302. The suggested user preferences element 306 may include one or more suggested user preference selections 280 of selected grocery items for the user 125. The suggested user preferences element 306 may include ripeness (e.g., of produce), the fattiness (e.g., of meats, dairy), expiration dates, origin (e.g., Ecuadorian coffee or produce), color, or any other data associated with user preferences 210. For example, the suggested user preference element 306 may include a suggested ripeness level of an apple grocery items that has been added to the cart 302. For example, the suggested user preference element 306 may include a slider user interface element set to a suggested position to indicate a suggested item preference. In some examples, the suggested user preference element 306 may be interactive. For example, a user 125 may interact (e.g., slide) the suggested user preference element 306 to change the suggested preference.

In some examples, the suggested user preferences element 306 may be determined by the one or more models 107 of the network system 101. For example, the network system 101 may include a user preference model trained to determine the preferences of a requesting user 125 by utilizing user preferences data 210 and feedback from the user 125. For instance, a user 125 may indicate user preferences for a grocery items on a previous order request and provide feedback that the requested grocery items did not meet the user preferences. In some examples, the one or more models 107 of the network system 101 may determine updated user preference selections 280 and update the suggested user preferences element 306 by utilizing the user data 106 including user preferences data 210 indicating the selected user preferences 280 of the previous order request and the feedback of the user. The updated suggested item preferences may compensate for any misalignment of the user preferences data 210 and the user preference selections 280 selected by the user 125. In some examples, the feedback of the user 125 may be used to further train the one or more models 107.

In some examples, suggested user preferences element 306 may be determined based on historical data 108. For instance, historical data 108 may indicate that a requesting user 125 has previously indicated a preference for a grocery items that has been added to the cart 302. The suggested user preference elements 306 may indicate a suggested user preference via the suggested user preferences element 306 based on the user's order history. For example, if a user 125 selected a one-time item user preference for apples indicating that apples should be over ripe in the previous 4 order requests, the suggested user preferences element 306 may indicate a suggested user preference of over ripe apples for an apple grocery item added to the cart 302.

The example user interface 300 may allow a requesting user 125 to submit an order request for grocery delivery services. For example, in response to user input by a user 125, the application 122 may interact with the user device 121 to display an application interface on a user interface 300 of the user device 121. The user 125 may select one or more grocery items from one or more merchant locations and add the grocery items to a cart 302. The user 125 may additionally or alternatively add one or more related grocery items 305 to the cart 302 and include one or more user preference selections 280 captured by the add user preferences element 303. In some examples, the user 125 may add or one or more suggested user selection preferences 280 via the suggested user preferences element 306 for each of the grocery items or related grocery items 305. The user 125 may checkout and submit the order request to the grocery delivery service entity. In some examples, the grocery delivery service entity may assign a shopper 135 to select the requested grocery items from the merchant location by transmitting data indicative of the order request to an available shopper device 131 associated with a shopper (e.g., shopper 135, merchant 145). In other examples, the shopper 135 (e.g., shopper, courier) may deliver the grocery items to the requesting using 125.

FIG. 4A-B depicts example user interfaces according to example aspects of the present disclosure. By way of example, the example user interface 400A depicted in FIG. 4A may be a user interface of a shopper device 131 associated with a shopper 135 to allow the shopper 135 to interact with a grocery delivery service entity. For example, in response to user input by a shopper 135, an application 132 may interact with the shopper device 131 to display an application interface on a user interface 400A of the shopper device 131.

For example, as depicted in FIG. 4A, the user interface 400A of a shopper device (e.g., shopper device 131) may display one or more lists 401A, 401B of the requested grocery items included in the order request. In some examples, the one or more list 401A, 401B may be organized by the category of grocery items. For instance, the one or more lists 401A, 401B may include a list for a category including fruits and vegetables (e.g., 401A) and a list including canned goods (e.g., 401B). Each grocery item may include an associated name, image, quantity, and price that identifies the requested grocery items within the grocery items element. In some examples, the one or more lists 401A, 401B may be organized by category based on the location of the grocery items within the merchant location. For instance, the fruits and vegetables list (e.g., 401A) includes an indication that the grocery items included in the fruits and vegetables list may be found in the produce section of the merchant location.

In some examples, a user interface of a shopper device 131 may include user preference selections 280 captured by the add user preferences element 303 from the user 125. For example, as depicted in FIG. 4B, the user interface 400B of the shopper device 131 may be updated to display a selected item 402 that the shopper 135 is preparing to select (e.g., “shop”). The shopper 135 may select the selected item 402 from one or more lists (e.g., 401A, 401B) via an interactive user interface element encapsulating an image and name of the selected item 402. Upon selecting (e.g., clicking) on the selected item 402, an updated user interface of the shopper device 131 may display the selected item 402, a user preference indicator 403, an interactive availability user interface element 405 that allows the shopper 135 to provide user input indicating that the selected item 402 is unavailable (e.g., out of stock), and an interactive scan item user interface element 404 that allows the shopper 135 to capture sensor data indicative of a plurality of available grocery items at the merchant location.

In some examples, the user interface 400B may include an interactive availability user interface element 405 that allows the shopper 135 to provide user input indicating that the selected item 402 is unavailable (e.g., out of stock). For example, the shopper 135 may arrive at the merchant location and determine that there are no available bananas. The shopper 135 may interact (e.g., click) the interactive availability user interface element 405 to provide user input that bananas are not available.

In some examples, the user interface 400B may include an interactive scan item user interface element 404 that allows the shopper 135 to capture sensor data indicative of a plurality of available grocery items at the merchant location. For example, the shopper 135 may arrive at the merchant location and determine there are available bananas. The shopper 135 may interact (e.g., click) the interactive scan item user interface element 404 which allows the shopper 135 to capture sensor data indicative of the available grocery items to determine the recommended bananas to select from the available bananas at the merchant location. An example shopper device 131 determining a recommended grocery items from a plurality of available grocery items is further described with reference to FIG. 5.

In some examples, the user preference indicator 403 may indicate user preference selections 280 captured by the add user preferences element 303 from the user 125. For instance, as depicted in FIG. 4B, the user preference indicator 403 indicates that the user 125 prefers bananas slightly under ripe. In some examples, the user preference indicator 403 may be a sliding scale. In some examples, the user preference indicator 403 may be numerical value. In some examples, the user preference indicator 403 may not allow the shopper to change (e.g., slide) the user preference selections 280 selected by the user 125. For example, the user preference indicator 403 may be a noninteractive user interface element.

In some examples, the user interface of the shopper device 131 may display a selectable user interface element that allows the shopper 135 to provide input that the requested grocery items are unavailable at the merchant location 301. For instance, as depicted in FIG. 4B, the user interface of the shopper device 131 may include an “Unavailable” user interface element 405 that allows the shopper 135 to indicate the organic bananas are unavailable at the merchant location.

FIG. 5 depicts a block diagram of an example data processing pipeline according to example aspects of the present disclosure. The following description of dataflow in data pipeline 500 is described with an example implementation in which the shopper device 131 utilizes sensors 503 (e.g., cameras) to capture sensor data 504 indicative of a plurality of grocery items and utilizes a plurality of models to generate output 508 indicative of a recommended grocery items 512 from the plurality of grocery items currently available at a merchant location. Additionally, or alternatively, one or more portions of the dataflow pipeline 500 may be implemented in the network system 101.

The shopper device 131 may receive sensor data 504 indicative of a plurality of grocery items currently available for selection at a merchant location. For example, the shopper device 131 may include one or more sensors 503 (e.g., cameras). The sensors 504 may include any type of image or optical sensor capable of capturing optical data of the environment. The sensors 503 may capture sensor data 504 including one or more image frames indicating grocery items currently available for selection at the merchant location.

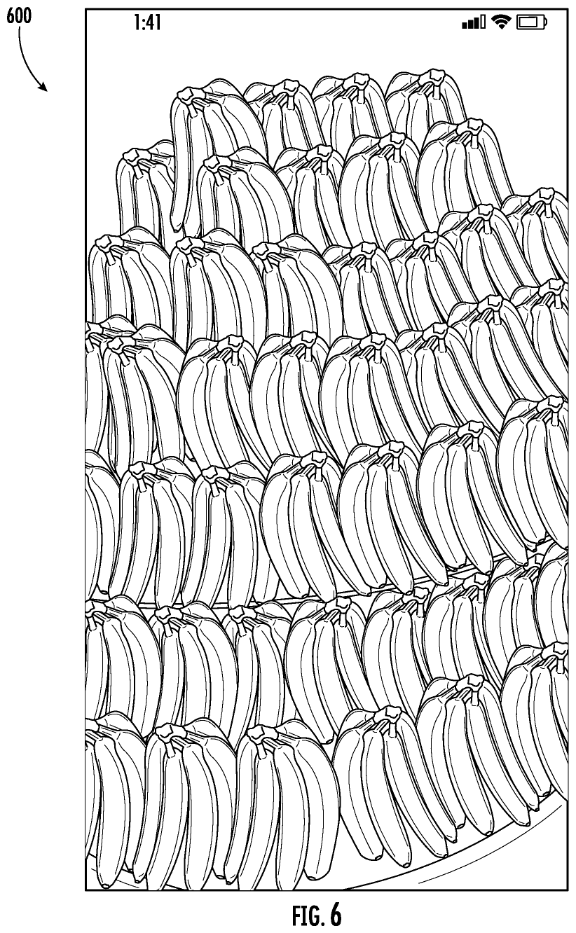

In some implementations, sensor data 504 may include a single image frame. For example, the example sensor data 504 can include a single image frame 600 depicting a plurality of available bananas at a merchant location, as shown in FIG. 6.

In some implementations, sensor data 504 may include multiple image frames. In some examples, the sensors 503 may capture sensor data 504 including a video recording of the grocery items currently available for selection at the merchant location.

Returning to FIG. 5, the sensor data 504 may include a plurality of image frames including grocery items captured over time. For instance, the sensors 503 may capture fist sensor data (e.g., sensor data 504) including image frames indicative of the plurality of grocery items and subsequently capture second sensor data 510 including image frames indicative of one or more recommended grocery items 512. In some examples, the second sensor data 510 may include an alternative point of view from the first sensor data 504. For example, the second sensor data 510 may include higher resolution images from the first sensor data. In other examples, the second sensor data 510 may include an alternative perspective (e.g., alternative angle of the grocery items). For instance, the second sensor data 510 may be used to confirm the determination of the recommended grocery items 512. For example, second sensor data 510 may include additional details associated with the grocery items that were not visible in the first sensor data 504. For instance, second sensor data 510 may reveal bruising on the bottom of a grocery items that was not visible in the first sensor data 504. The additional details associated with bruising may be used to determine a second recommended item or confirm a first recommended item.

The shopper device 131 may include a plurality of machine-learned models that utilize the sensor data 504, 510 to determine output 508 indicative of a recommended item. For instance, the shopper device 131 may utilize one or more models such a machine-learned item detection model 501 and a machine-learned item recommendation model 502.

In an embodiment, the item detection model 501 may be an unsupervised learning model configured to detect, identify, and segment grocery items depicted in an image frame. In some examples, the item detection model 501 may include one or more machine-learned models. For example, the item detection model 501 may include a machine-learned model trained to detect a specific category (e.g., produce, meat, etc.) or type (bananas, steak, etc.) of grocery items. In some examples, the item detection model 501 may include a machine-learned model trained to detect any category or type of grocery items. In other examples, the item detection model 501 may include a machine-learned model trained to distinguish individual grocery items from similar grocery items available at a merchant location by executing segmentation techniques.

The item detection model 501 may be or may otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks.

The item detection model 501 may be trained through the use of one or more model trainers and training data. The model trainers may be trained using one or more training or learning algorithms. One example training technique is backwards propagation of errors. In some examples, simulations may be implemented for obtaining the training data or for implementing the model trainer(s) for training or testing the model(s). In some examples, the model trainer(s) may perform supervised training techniques using labeled training data. As further described herein, the training data may include labelled image frames that have labels indicating a type of item and the segmentation of items (e.g., one banana from a cluster of bananas). In some examples, the training data may include simulated training data (e.g., training data obtained from simulated scenarios, inputs, configurations, grocery store environments, etc.).

Additionally, or alternatively, the model trainer(s) may perform unsupervised training techniques using unlabeled training data. By way of example, the model trainer(s) may train one or more components of a machine-learned model to perform item detection through unsupervised training techniques using an objective function (e.g., costs, rewards, heuristics, constraints, etc.). In some implementations, the model trainer(s) may perform a number of generalization techniques to improve the generalization capability of the model(s) being trained. Generalization techniques include weight decays, dropouts, or other techniques.

The item detection model 501 may receive sensor data 504, 510 indicative of a plurality of grocery items currently available for selection at a merchant location. In some examples, the item detection model 501 may be trained to detect grocery items and segment one or more grocery items from a plurality of grocery items by performing segmentation techniques. Segmentation techniques may include analyzing the sensor data 504, 510 including one or more image frames. For example, the item detection model 501 may obtain characteristics of the grocery items by projecting a bounding shape on the image frames.

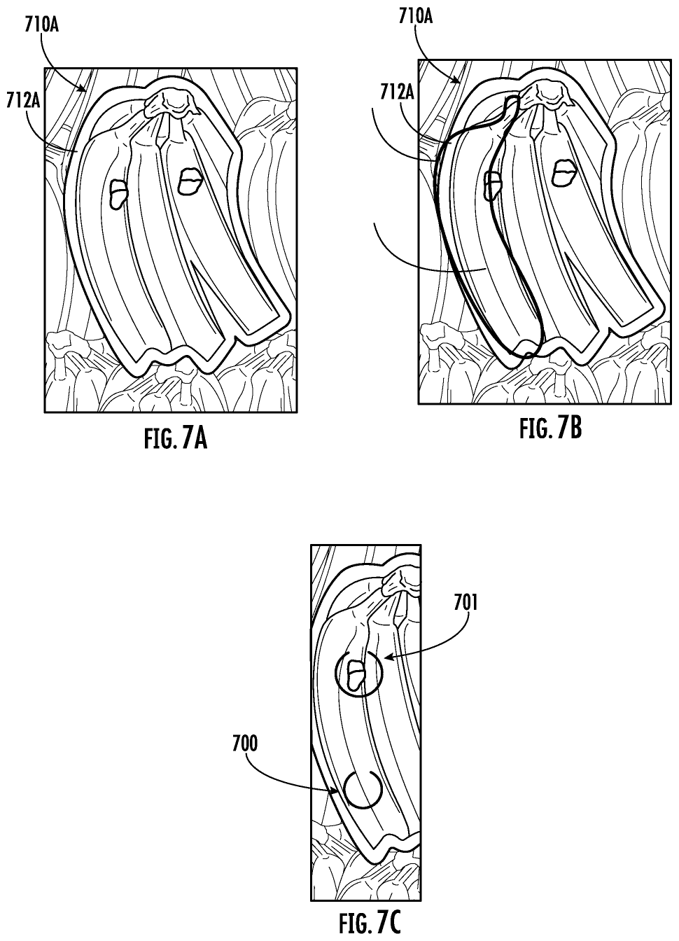

The bounding shape may be any shape (e.g., polygon) that includes one or more grocery items. For example, as shown in FIG. 7A, a bounding shape 710A may include a shape that matches the outermost boundaries and the contours of those boundaries for a cluster of items 712A (e.g., bananas). Additionally, or alternatively, as shown in FIG. 7B, a bounding shape 710B may include a shape that matches the outermost boundaries and the contours of those boundaries for an individual item 712B (e.g., a single banana). One of ordinary skill in the art will understand that other shapes may be used such as squares, circles, rectangles, etc. In some implementations, the bounding shape 710A-B may be generated on a per pixel level. The item characteristics may include the x, y, z coordinates of the bounding shape center, the length, width, and height of the bounding shape, etc.

Returning to FIG. 5, the item detection model 501 may generate data (e.g., labels) that correspond to the grocery items characteristics of the bounding shape. Labels may include the classification of grocery items (e.g., produce, meat, dairy, etc.), the type of grocery items (e.g., bananas, steak, milk, etc.), quantity (e.g., single banana or cluster of bananas), color, gradient (e.g., changes in color), etc.

The item detection model 501 may execute item segmentation techniques to distinguish individual items from a plurality of items available at a merchant location. For example, the item detection model 501 may receive sensor data 504, 510 that includes an image frame depicting a display of multiple items such as a banana display with multiple banana clusters (e.g., FIG. 6). The item detection model may project an anchor bounding shape that encapsulates all of the items that are depicted on the display. In some examples, the item detection model 501 may further analyze the items within the anchor bounding shape. For example, the item detection model 501 may distinguish each item by iteratively projecting a bounding shape encapsulating each individual item depicted in the anchor bounding shape. In some examples, the item detection model may iteratively resize the anchor bounding shape to encapsulate each detected item within the image frame.

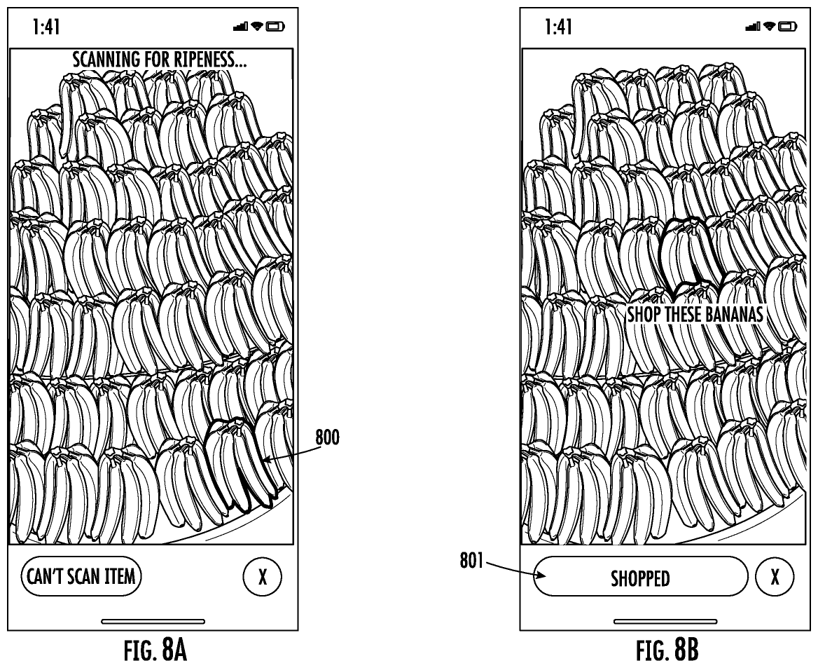

For example, as shown in FIG. 8A the example user interface of a shopper device 131 displays the segmentation of a cluster of bananas 800 from the plurality of bananas available at a merchant location. In some examples, the item detection model 501 may label each item as separate grocery items. For example, the item detection model 501 may generate a unique identification label for each item depicted in the image frame. The identification label may indicate the item as being unique grocery items within the plurality of grocery items depicted in the image frame.

The item detection model 501 may execute item segmentation techniques before, during, or after generating feature characteristics (e.g., identifying grocery items) of grocery items. For example, the item detection model 501 may generate unique identification labels indicating the segmented grocery items prior to determining the grocery items are apples and generating an apple label type. In some examples, the item detection model 501 may generate unique identification labels indicating the segmented grocery items, determine the grocery items are apples, and generate an apple label type concurrently.

For example, as shown in FIG. 7C, grocery items such as bananas may include a sticker or label on each of the grocery items. Label 701 may indicate that the grocery items are bananas and allow the item detection model 501 to generate a banana label type concurrently with a unique identification label. In some examples, grocery items in a cluster may include one sticker or label 701 on an individual grocery item of the cluster and the item detection model 501 may infer all grocery items in the cluster are of the same item type. In other examples, the item detection model 501 may generate unique identification labels indicating the segmented grocery items after determining the grocery items are apples and an apple label type has been generated.

In some examples, a quantity label may have an integer value. For example, the item detection model 501 may determine the quantity label of grocery items has a value greater than one (e.g., cluster of grapes, cluster of bananas, etc.) and generate a segmentation label. By way of example, the item detection model 501 may determine the quantity label of grocery items has a value greater than one by determining grocery items encapsulated in the bounding shape includes a common stem (e.g., stem of a grape vine, stem of banana cluster, etc.) connecting multiple grocery items. For example, as shown in FIG. 7A, the cluster of bananas may have a quantity label with a value greater than one due to the presence of a stem connecting at least five visible bananas. The segmentation label may indicate that grocery items include multiple grocery items (e.g., one banana from a cluster of bananas). The item detection model 501 may generate labels for each of the grocery items included in the cluster (e.g., each banana in the cluster of bananas). In some examples, the item detection model 501 may determine grocery items requires additional processing to label each of the grocery items included in the cluster based on the segmentation label.

In some examples, the segmentation labels may concatenate labels for each of the grocery items and generate a cluster label for the grocery items. A cluster label may indicate the grocery items includes a cluster of individual grocery items including labels for each individual grocery items in the cluster. In some examples, the cluster label may indicate that additional sensor data is required to detect each of the grocery items included in the cluster of grocery items. For example, the item detection model 501 may determine that an image frame includes a cluster of grapes and determine that some grapes are partially occluded. In some examples, the item detection model may generate a command instruction to generate an updated user interface of the shopper device 131 that instructs the shopper 135 to obtain additional sensor data 504 of the cluster grocery items. In some examples, the object detection mode 501 may generate labels for partially occluded grocery items in the cluster grocery items. For example, the item detection model 501 may generate labels by predicting a bounding shape around the partially occluded grocery items. For instance, the item detection model 501 may include a context-aware compositional neural network configured to detect partially occluded grocery items.

The item detection model 501 may obtain request data 505 indicative of the order request submitted by the user 125. Request data 505 may include data associated with the order request that allows the shopper 135 to select the requested grocery items from the merchant location. For example, request data 505 may include data such as the request identifier 205, item ids 260, quantity 270, user preference selections 280, and any other data that may be required to allow the shopper 135 to select the grocery items from the merchant location.

In some examples, the item detection model 501 may determine how granularly to segment grocery items based on request data 505. For example, if a user 125 requested individual grocery items typically sold in a cluster, the item detection model 501 may segment each of the grocery items in a cluster based on the request data indicative of the quantity 270 of the requested grocery items. In some examples, the item detection model 501 may execute additional item segmentation techniques after a cluster of grocery items has been identified.

In some examples, the item detection model 501 may be trained to receive request data 505 as input to determine whether the grocery item detected in the sensor data 504 matches an item requested in the order request. For example, the item detection model 501 may determine that grocery items depicted in an image frame includes a label indicating the grocery items is an orange. The item detection model 501 may determine that the user 125 did not request any oranges based on the request data 505 and determine that the shopper 135 has selected the wrong grocery items. In some examples, the item detection model 501 may generate a command instruction to generate an updated user interface of the shopper device 131 that indicates the grocery items depicted in the sensor data 504 is not the correct grocery items requested by the user 125.

In some examples, the item detection model 501 may be trained to determine that the image frame includes multiple types of grocery items. For example, the item detection model 501 may determine there are different grocery items depicted in the sensor data 504. The item detection model 501 may determine there are oranges and a partial view of grapes depicted in an image frame. The item detection model 501 may utilize request data 505 to determine the user 125 requested grapes but did not request oranges. In some examples, the item detection model 501 may generate a command instruction to generate an updated user interface of the shopper device 131 that indicates the shopper 135 has selected the incorrect grocery items. In some examples, the item detection model 501 may generate a command instruction to generate an updated user interface of the shopper device 131 that indicates the shopper 135 needs to capture additional sensor data 504 of the grapes. In other examples, the item detection model 501 may determine the partial representation of the grapes is sufficient to generate output data 507.

The item detection model 501 may utilize sensor data 504 and request data 505 to generate item detection output 507. Item detection output 507 may include one or more labelled image frames identifying each of the grocery items depicted in the sensor data 504, 510. For example, item detection output 507 may include labelled image frames that indicate a classification of grocery items (e.g., produce, meat, dairy, etc.), the types of grocery items (e.g., bananas, steak, milk, etc.), quantity (e.g., single banana or cluster of bananas), color, gradient (e.g., changes in color), etc. In some examples, the item detection output 507 may include segmented (e.g., cropped) image frames including individual grocery items. For example, the item detection output 507 may include image frames segmented based on the grocery items requested by the user 125. For instance, the item detection output 507 may segment bananas individually, where the user 125 requested a single banana. In some examples, the item detection output 507 may be used as input to the item recommendation model 502.

In an embodiment, the item recommendation model 502 may be a machine-learned model configured to analyze a plurality of image frame to determine characteristics indicative of grocery items available at a merchant location 301 to identify a recommended grocery item 512 by applying user preference selections 280. In some examples, the item recommendation model 502 may include one or more machine-learned models. For example, the item recommendation model 502 may include a machine-learned model trained to detect feature characteristics (e.g., bruising, saturated colors, indentations, stem size or color, or shiny appearance, etc.) of grocery items. In some examples, the item recommendation model 502 may include a machine-learned model trained to detect feature characteristics based on item type or category. In some examples, the item recommendation model 502 may include a single machine-learned model trained to detect feature characteristics of any category or type of grocery items. In other examples, the item recommendation model 502 may include a machine-learned model trained to compare the feature characteristics of the available grocery items at a merchant location with the user preference selections 280 selected by the user 125.

The item recommendation model 502 may be an unsupervised learning model configured to determine output data 508 indicative of recommended grocery items 512. The item recommendation model 502 may be or may otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks.

The item recommendation model 502 may be trained through the use of one or more model trainers and training data. The model trainers may be trained using one or more training or learning algorithms. One example training technique is backwards propagation of errors. In some examples, simulations may be implemented for obtaining the training data or for implementing the model trainer(s) for training or testing the model(s). In some examples, the model trainer(s) may perform supervised training techniques using labeled training data. As further described herein, the training data may include labelled image frames that have labels indicating a type of item and the segmentation of items (e.g., one banana from a cluster of bananas). In some examples, the training data may include simulated training data (e.g., training data obtained from simulated scenarios, inputs, configurations, grocery store environments, etc.).

Additionally, or alternatively, the model trainer(s) may perform unsupervised training techniques using unlabeled training data. By way of example, the model trainer(s) may train one or more components of a machine-learned model to perform item detection through unsupervised training techniques using an objective function (e.g., costs, rewards, heuristics, constraints, etc.). In some implementations, the model trainer(s) may perform a number of generalization techniques to improve the generalization capability of the model(s) being trained. Generalization techniques include weight decays, dropouts, or other techniques.

The item recommendation model 502 may receive item detection output 507 including processed sensor data 504 indicative of a plurality of grocery items currently available for selection at a merchant location. For example, the item recommendation model 502 may receive as input a plurality of labelled image frames indicating grocery items available at the merchant location.

The item recommendation model 502 may be trained to determine recommended grocery items 512 based on user preference data 506 by analyzing the item detection output 507 including one or more labelled image frames. For example, the item recommendation model 502 may obtain user preference data 506 including one or more user preference selections selected by the user 125. User preference selections 280 may include ripeness (e.g., of produce), the fattiness (e.g., of meats, dairy), expiration dates, origin (e.g., Ecuadorian coffee or produce), color, or any other data associated with a user preferences. The item recommendation model 502 may analyze the item detection output to generate labels indicative of preference characteristics of the grocery items.

The item recommendation model 502 may utilize item detection output 507 and user preference data 506 to generate labels associated with characteristics indicated in the user preference selections 280. Such item characteristic labels may indicate the ripeness (e.g., of produce), the fattiness (e.g., of meats, dairy), expiration dates, origin (e.g., Ecuadorian coffee or produce), color, or any other characteristic if the quality and readiness to be eaten.

For instance, the item recommendation model 502 may utilize item detection output 507 and user preference data 506 to generate ripeness labels that indicate a ripeness of the grocery items. In some examples ripeness labels may indicate feature characteristics of grocery items that indicate the quality and readiness to be eaten. By way of example, ripeness labels may include feature characteristics of grocery items such as bruising, saturated colors, indentations, stem size or color, or shiny appearance. An example ripeness label including bruising is depicted in FIG. 7C. The bruising 700 on the banana may be a ripeness label indicating the banana has slight bruising and is ripe. In some examples, ripeness labels generated for an individual grocery items in a cluster may be concatenated across the entire cluster. For instance, severe bruising on an individual banana may be indicative of the ripeness of the entire cluster of bananas. In other examples, ripeness labels may be generated based on the executed segmentation techniques. For example, the item detection model 501 may segment grocery items on a cluster by groups of three based on request data 505 that indicates the user 125 requested a quantity of three grocery items of the same type. In some examples, the ripeness label may be generated for the cluster of grocery items rather than each individual grocery items.

The item recommendation model 502 may utilize the characteristic labels and user preference data 506 to generate a ripeness rating for produce associated with a particular characteristic of the grocery items. For instance, the item recommendation model 502 may utilize a ripeness labels and user preference data 506 to generate a ripeness rating indicative of the ripeness of the grocery items. The item recommendation model 502 may be trained to compute a ripeness rating based on a variety of labels. For instance, the ripeness rating may be a graphic rating scale, numerical rating scale, descriptive rating scale, comparative rating scale or any form of rating scale that allows for consistent rating outcomes. For instance, the item recommendation model 502 may compute an integer that falls within a numerical rating scale based on determining a threshold number of ripeness labels for grocery items. In some examples, the item recommended model 502 may compute a comparison rating for a grocery items based on determining specific ripeness labels for a grocery items where the comparison rating compares the grocery items to an unripe, perfectly ripe, or spoiled grocery items of the same type. In other examples, the item recommendation model 502 may compute a descriptive rating based on determining one or more ripeness labels for grocery items where the descriptive rating describes the ripeness labels. For instance, descriptive ripeness rating may compute a ripeness of spoiled based on determining severe bruising or indentation labels for the grocery items.

The item recommendation model 502 may generate a ratings for any type of food. For example, the item recommended model 502 may generate a fattiness rating for meat. By way of example, the item recommendation mode 502 may utilize fattiness labels and user preference data 506 to generate a fattiness rating indicative of the fatty composition of the grocery items. For instance, the item recommendation model 502 may generate a descriptive fattiness rating of high fatty composition for steak based on multiple fat labels that indicate the presence of lighter textured portions (e.g., fat). The item recommendation model may determine based on the user preference data 506 that the user 125 requested steak containing a high fatty composition and determine the recommended grocery item 512 based on the fat labels meeting a minimum threshold. In some examples, the item recommendation model 502 may determine the fattiness rating contains a moderate fatty composition by determining the presence of other labels such as color labels, gradient labels (e.g., changes in color), etc.,

In some examples, the item recommendation model 502 may determine the fattiness rating based on descriptive information such as a sticker label on meat. For example, grocery items may include a sticker or label that indicates the composition of the grocery items. By way of example, meat stored in packaging may include a label that describes the composition of the meat. For instance, ground turkey may include a sticker or label that indicates the ground turkey is 85% lean and 15% fat. The item recommendation model 502 may determine the fattiness rating of ground turkey by determining a sticker or label indicates the composition of ground turkey. In some examples, the item recommendation model 502 may determine the recommended item based on comparing the sticker or label composition to the user preference selections 280 selected by the user 125. In other examples, the item recommendation model 502 may determine the recommended grocery items 512 based on the sticker or label indicting that the indicated composition falls within a threshold of the user preference selections 280 selected by the user 125.

The item recommendation model 502 may generate a rating for any type of grocery item. For examples, the recommendation model 502 may generate a rating for expiration dates, origin (e.g., Ecuadorian coffee or produce), color, or any other data associated with user preferences using the described approach. In some implementations, the item detection model may adjust a rating based on user preference data 506 and request data. For instance, the item detection model may adjust the ripeness rating based on user preference data 506 and request data. For example, user preference data 506 may indicate that a user 125 prefers slightly unripe produce items. For example, as shown in FIG. 4B, the example user interface of a shopper device 131 indicates a ripeness user interface element 403 depicting user preference selections 280 of slightly under ripe bananas. In some examples, request data may indicate that the user 125 is located in a geographic region where slightly under ripe produce correlates to the presence of less bruising. The item recommendation model 502 may adjust the ripeness rating to indicate that under ripe produce should include little to no bruising. In some examples, the user preference data 506 may indicate that a user 125 prefers slightly under ripe produce items and request data 505 may indicate that the user 125 is located in a geographic region where slightly under ripe produce correlates to a shiny appearance. The item recommendation model 502 may adjust the ripeness rating to indicate that under ripe produce should have a significant shiny appearance.

The item detection model 502 may utilize user preference data 506 to determine recommended grocery items 512 from the plurality of grocery items available at the merchant location. Recommended grocery items 512 may include the grocery items to that have been determined to satisfy the preferences (e.g., user preference selections 280) selected by the user 125. For example, the user preference data 506 may include user preference selections 280 based on the user 125 interacting with the add item preferences element 303 or suggested user preferences element 306. The item recommendation model 502 may determine recommended grocery items 512 based on determining the ripeness rating of one or more grocery items meets the ripeness preference specified by the user 125. In some examples, the item recommendation model 502 may determine the recommended grocery items 512 by determining one or more of the available grocery items meets a threshold ripeness rating compared to the ripeness preference specified by the user 125. In some examples, the item recommendation model 502 may determine recommended grocery items 512 by determining the ripeness rating of one or more available grocery items exceeds the ripeness preference specified by the user 125.

In some examples, recommended grocery items 512 may indicate partial grocery items (e.g., part of a steak). In some examples, recommended grocery items 512 may indicate a plurality of grocery items. In some examples, recommended grocery items 512 may indicate individual grocery items. In other examples, the item recommendation model 502 may determine one or more recommended grocery items 512 based on determining previous recommended grocery items. For instance, the item recommendation model 502 may determine a cluster of grocery items are the recommended grocery items 512 based on determining one or more individual recommended grocery items 512 included in the cluster of grocery items. For example, the item recommendation model 502 may determine one or more bananas are recommended grocery items 512 and determine the entire cluster of bananas are recommended grocery items 512 based on determining the one or more bananas are recommended grocery items 512.

The item recommendation model 502 may generate output 508 indicative of the recommended grocery item 512. Output 508 may include one or more labelled image frames indicating the recommended grocery items 512. In some examples, output data 508 may include values of labels associated with a bounding shape. For instance, the values of labels associated with a bounding shape may be stored in an array that may be accessible by other systems, subsystems or models of the computing system 100. In some examples, output 508 may include one or more command instructions that may be executed by the application 122 running on the shopper device to cause the application to interact with the shopper device 131 to display the recommended grocery item 512. For instance, the recommended grocery item 512 may be indicated as a grocery items among a plurality of grocery items available at a merchant location 301. For example, as shown in FIG. 8B, the recommended bananas may be indicated as the recommended bananas from among the bananas available at the merchant location. In some examples, the output 508 may indicate multiple recommended grocery items 512 from the plurality of grocery items available at the merchant location 301. In some examples, the shopper may indicate that the recommended grocery items 512 have been selected. For example, as shown in FIG. 8B, the shopper device 131 may include an interactive user interface element that allows the shopper 135 to provide user input that the recommended bananas have been selected by selecting the “shopped” user interface element 801.

In some implementations, the item recommendation model 502 may generate output 508 that indicates that none of the available grocery items from the plurality of available grocery items satisfies the user preferences 303. For example, a user 125 may include a user preference 303 indicating that steak contain a high fatty composition (e.g., fattiness level). The item recommendation model 502 may determine that none of the available steak at the merchant location contains a high fatty composition and generate output 508 indicating that no recommended grocery items are available. For instance, output 508 may include one or more command instructions that may be executed by the application 122 running on the shopper device 131 to cause the application to interact with the shopper device 131 to display a user interface indicating the steak is unavailable. In some examples, output 508 may include one or more command instructions that may be executed by the application 132 running on the shopper device 131 to cause the application 132 to interact with the shopper device 131 to display replacement grocery items that may be used to substitute the unavailable grocery items.

In some examples, the item recommendation model 502 may determine that there are not enough recommended grocery items to satisfy the quantity of requested grocery items. For example, the item recommendation model 502 may utilize request data 506 and user preference data 506 indicating the quantity and user preference selections 280 of grocery items. In some examples, output 508 may include one or more command instructions that may be executed by the application 132 running on the shopper device to cause the application 132 to interact with the shopper device 131 to display the recommended grocery items 512 that meet the user preference selections 280, notwithstanding the recommended grocery items 512 do not meet the quantity of grocery items requested. In some examples, output 508 may include one or more command instructions that may be executed by the application 132 running on the shopper device 131 to cause the application 132 to interact with the shopper device 131 to indicate the grocery items are unavailable. In other examples, output 508 may include one or more command instructions that may be executed by the application 322 running on the shopper device 131 to cause the application to interact with the shopper 132 device 131 to display a replacement grocery items that may be used to substitute grocery items that does not meet the quantity requested by the user 125.

Replacement grocery items may be determined by the user 125 upon creation of the order request. For instance, the user 125 may indicate that a related grocery item 305 may substitute grocery items that are no longer available at the merchant location. By way of example, the user 125 may indicate that bone-in porkchops may serve as a replacement item in the event that steak of a particular fattiness level is not available. In some examples, replacement grocery items may be determined by the network computing system 101. For example, a user 125 may fail to indicate a replacement grocery item during the creation of the order request and the one or more models 107 of the network system 101 may determine that the user 125 selected a replacement grocery item for previous order requests and determine the replacement grocery item based on the previous order history. By way of example, the network system 101 may determine that, in a previous order, a user previously selected a high fat yogurt as a replacement item for full fat sour cream. In another example, the network system 101 may determine that 85% fat ground beef may be a replacement item for 80% fat ground beef because the fattiness is within an range that has historically been acceptable to multiple users of the delivery service or within a range previously found acceptable by the suer 125. The network system 101 can utilize this past information to determine that such yogurt (or 85% fat beef) may be a replacement item for sour cream (or 80% fat beef) for the current order request.

In some examples, the output 508 may be stored in the data repository 105. For example, output data 508 may be used to further train the one or more models 107 of the network system 101, the item detection model 501, or the item recommendation model 502. For instance, once a user 125 receives the delivery including the recommended grocery items 512, the user 125 may provide feedback indicating whether the recommended grocery items 512 met the user preference selections 280. In some examples, the output 508 may be used to retrain the item recommendation model 502 based on the feedback provided by the user 125. For instance, the user device 121 may transmit feedback data to the network system 101. In some examples, the application 122 may interact with the user device 121 to display a feedback element on the user interface of the user device 121. The user 125 may provide feedback indicating satisfaction or dissatisfaction with the recommended grocery items 512.

In some examples, the user 125 may indicate feedback associated with output 508 (e.g., recommended grocery item 512 based on user preference selections 280). For example, the user 125 may receive the sensor data 504 including the image frames depicting the available grocery items and the recommended grocery item 512. The user 125 may provide feedback indicating that grocery items not selected as the recommended item would have satisfied the user preference selections 280 instead of the recommended grocery items 512. In some examples, the feedback may be used to retrain the item recommendation model 502. In some implementations, the feedback may be provided prior to delivery of the requested grocery items (e.g., based on the order updates including image frames).

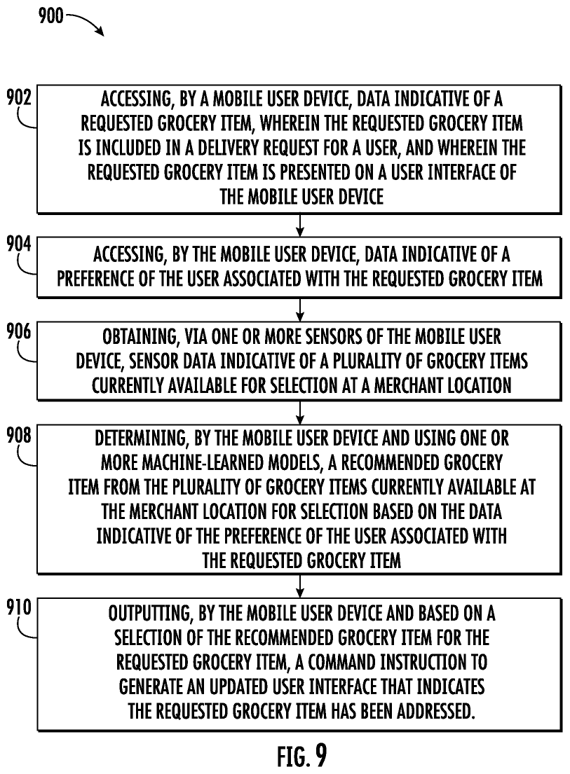

FIG. 9 depicts a flowchart diagram of an example method according to example aspects of the present disclosure. One or more portion(s) of the method 900 may be implemented by one or more computing devices such as for example, the computing devices/systems described in FIGS. 1, 5, 10, etc. Moreover, one or more portion(s) of the method 900 may be implemented as an algorithm on the hardware components of the device(s) described herein. For example, a computing system may include one or more processors and one or more non-transitory, computer-readable media storing instructions that are executable by the one or more processors to cause the computing system to perform operations, the operations including one or more of the operations/portions of method 900. FIG. 9 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure.

In an embodiment, the method 900 may include a step 902 or otherwise begin by accessing, by a mobile user device, data indicative of a requested grocery item wherein the requested grocery item is included in a delivery request for a user, and wherein the requested grocery item is presented on a user interface of the mobile user device. For instance, a shopper device 131 may access an order request which includes requested grocery items by a user 125. For example, the user 125 may submit via an application 122 running on a user device 121, an order request including grocery items available at a merchant location. A network system 101 (e.g., grocery delivery service entity) may receive the order request from the user device 121 and an order request subsystem 104 may process the order request to coordinate with a shopper 135 via the shopper device 131 to select and/or delivery the requested grocery items. The network system 101 may make the order request accessible to the shopper device 131 to allow the shopper 135 to select the requested grocery items from the merchant location.

For instance, in response to user input by a shopper 135, an application 132 may interact with the shopper device 131 to display an application interface on a user interface 400A of the shopper device 131. The user interface 400A of a shopper device (e.g., shopper device 131) may display one or more lists 401A, 401B of the requested grocery items included in the order request.

The method 900 may include a step 904 or otherwise continue by accessing, by the mobile user device, data indicative of a preference of the user associated with the requested grocery item. For instance, the user 125 may select one or more user preference selections 280 via the add item preferences element 303 or the suggested user preferences element 306 for each of the requested grocery items. As described herein, the user may indicate that grocery items must meet user preference selections 280 (e.g., a ripeness level or fattiness level) in order to be selected (e.g., “shopped”). By way of example, the user 125 may include bananas and steak in the order request. The user 125 may indicate user preference selections 280 that the bananas are under ripe (e.g., ripeness level) and user preference selections 280 that the steak have an 80% fat composition (e.g., fattiness level). The user preference selections 280 selected by the user 125 may be included in the order request submitted by the user 125. In some examples, the user preference selections 280 may be saved in user data 106 within a data repository 106 of the network system. In some examples, the user preference selections 280 may be saved in historical data 108 of the network system.

The shopper device 131 (e.g., mobile user device) may access the order request or data stored in the data repository 105 of the network system 101. For instance, the user interface 400B of a shopper device 131 may include user preference selections 280 selected by the user 125. The shopper 135 may select a grocery item from the lists (e.g., 401A, 401B) via an interactive user interface element on the display of the shopper device 131. Upon selecting (e.g., clicking) on the grocery item, a user interface 400B of the shopper device 131 may display the grocery items and user preference indicator 403 which includes the user preference selections 280 of the user 125.

The method 900 may include a step 906 or otherwise continue by obtaining, via one or more sensors of the mobile user device, sensor data indicative of a plurality of grocery items currently available for selection at a merchant location. For instance, the shopper device 131 may receive sensor data 504 indicative of a plurality of grocery items currently available for selection at a merchant location. The shopper device 131 may include one or more sensors 503 (e.g., cameras). Sensor data 504 may include a single image frame, multiple image frames, or video recording of the grocery items currently available for selection at the merchant location. In some examples, the sensor data 504 may include a plurality of image frames including grocery items captured over time. For instance, the sensors 503 may capture fist sensor data (e.g., sensor data 504) including image frames indicative of the plurality of grocery items and subsequently capture second sensor data 510.

In some examples, the second sensor data 510 may include an alternative point of view from the first sensor data 504. For example, the second sensor data 510 may include higher resolution images from the first sensor data 504. In some examples, second sensor data 510 may include additional details associated with the grocery items that were not visible in the first sensor data 504. For instance, second sensor data 510 may reveal bruising on the bottom of grocery items that was not visible in the first sensor data 504.

The method 900 may include a step 908, or otherwise continue by determining, by the mobile user device and using one or more machine-learned models, a recommended grocery item from the plurality of grocery items currently available at the merchant location for selection based on the data indicative of the preference of the user associated with the requested grocery item. For instance, the shopper device 131 may include a plurality of machine-learned models that utilize the sensor data 504, 510 to determine output 508 indicative of recommended grocery items 512. For example, the shopper device 131 may utilize a machine-learned item detection model 501 and a machine-learned item recommendation model 502.

The item detection model 501 may receive sensor data 504, 510 indicative of a plurality of grocery items currently available for selection at a merchant location. The item detection model 501 may detect grocery items and segment one or more grocery items from a plurality of grocery items by performing segmentation techniques. As described herein, example segmentation techniques may include analyzing the sensor data 504 including one or more image frames to distinguish individual grocery items from a plurality of items available at a merchant location.

The item detection model 501 may utilize the sensor data 504 and request data 505 (e.g., order request) to generate item detection output 507. Item detection output 507 may include one or more labelled image frames identifying each of the grocery items depicted in the sensor data 504, 510. For example, item detection output 507 may include labelled image frames that indicate a classification of grocery items (e.g., produce, meat, dairy, etc.), the types of grocery items (e.g., bananas, steak, milk, etc.), quantity (e.g., single banana or cluster of bananas), color, gradient (e.g., changes in color), etc. In some examples, the item detection output 507 may include segmented (e.g., cropped) image frames including individual grocery items. For example, the item detection output 507 may include image frames segmented based on the grocery items requested by the user 125. For instance, the item detection output 507 may segment bananas individually, where the user 125 requested a single banana. In some examples, the item detection output 507 may be used as input to the item recommendation model 502.

The item recommendation model 502 may receive item detection output 507 including processed sensor data 504 indicative of a plurality of grocery items currently available for selection at a merchant location. For example, the item recommendation model 502 may receive as input a plurality of labelled image frames indicating grocery items available at the merchant location.

The item recommendation model 502 may determine characteristics indicative of grocery items available at a merchant location to determine a recommended grocery item 512 by applying the user preference selections 280. For example, the item recommendation model 502 may detect feature characteristics (e.g., bruising, saturated colors, indentations, stem size or color, or shiny appearance, etc.) of grocery items. For instance, the item recommendation model 502 may utilize item detection output 507 and user preference data 506 to generate ripeness labels that indicate a ripeness of the grocery items. In some examples ripeness labels may indicate feature characteristics of grocery items that indicate the quality and readiness to be eaten. By way of example, ripeness labels may include feature characteristics of grocery items such as bruising, saturated colors, indentations, stem size or color, or shiny appearance. For instance, the bruising 700 on the banana may be a ripeness label indicating the banana has slight bruising and is ripe. In some examples, ripeness labels generated for an individual grocery items in a cluster may be concatenated across the entire cluster. For instance, severe bruising on a banana may be indicative of the ripeness of the entire cluster of bananas (or that a particular banana or cluster may not be accepted). In other examples, ripeness labels may be generated based on the executed segmentation techniques. For example, the item detection model 501 may segment grocery items on a cluster by groups of three based on request data 505 that indicates the user 125 requested a quantity of three grocery items of the same type. In some examples, the ripeness label may be generated for the cluster of grocery items rather than each individual grocery item.

The item recommendation model 502 may utilize the characteristic labels and user preference data 506 to generate a rating associated with a particular characteristic of the grocery items. For instance, the item recommendation model 502 may utilize a ripeness labels and user preference data 506 to generate a ripeness rating indicative of the ripeness of the grocery items. The item recommendation model 502 may compute a ripeness rating based on a variety of labels. The item recommendation model 502 may determine a recommended grocery item 512 by determining the ripeness rating of available grocery items matches or falls within a threshold of the user preference selections 280 selected by the user 125.

The method 900 may include a step 910, or otherwise continues by outputting, by the mobile user device and based on a selection of the recommended grocery item for the requested grocery item, a command instruction to generate an updated user interface that indicates the requested grocery item has been addressed. For instance, the item recommendation model 502 may generate output 508 indicative of the recommended grocery item 512. Output 508 may include one or more labelled image frames indicating the recommended item. In some examples, output data 508 may include values of labels associated with a bounding shape.

The output 508 may include one or more command instructions that may be executed by the application 132 running on the shopper device to cause the application 132 to interact with the shopper device 131 to display the recommended grocery item 512. For instance, the recommended grocery item 512 may be indicated as a grocery items among a plurality of grocery items available at a merchant location. For example, the recommended bananas may be indicated as the recommended bananas from among the bananas available at the merchant location. In some examples, the output 508 may indicate multiple recommended grocery items 512 from a plurality of grocery items available at the merchant location. The shopper 135 may indicate that the recommended grocery items 512 have been selected. For example, the shopper device 131 may include an interactive user interface element that allows the shopper 135 to provide user input that the recommended bananas have been selected by selecting the “shopped” user interface element 801.

In some examples, the method 900 may include accessing, by the mobile user device, data indicative of the one or more machine-learned models based on a type of the requested grocery item. As described herein, the one or more models may include one or more item detection models 501, where the mobile user device (e.g., shopper device 131) may access one of the one or more item detection models 501 based on the type of grocery item. For instance, a user 125 may add yogurt, apples, and ground turkey to the order request. The shopper device 131 may access an item detection model 501 configured to detect only yogurt, an item detection model 501 configured to detect only apples, and an item detection model 501 configured to detect only ground turkey. For example, the one or more item detection models 501 may include one or more machine-learned models configured to detect a specific grocery item. In some examples, the shopper device 131 may utilize the request data 505 to determine the grocery items requested by the user 125. In some examples, the shopper device 131 may access one or more item detection models 501 based on the request data 505 including the requested grocery items.

In some examples, the method 900 may include accessing, by the mobile user device, data indicative of the one or more machine-learned models based on the user associated with the requested grocery item. As described herein, the one or models may include one or more item recommendation models 502, where the mobile user device (e.g., shopper device 131) may access one or more item recommendation models 502 based on the user (e.g., user 125). For instance, the one or more item recommendation models 502 may be trained by feedback of a user 125. In some examples, the one or more item recommendation models 502 may include an item recommendation model 502 for a specific user 125. For example, user A may utilize the grocery delivery service and provide feedback that the recommended grocery items 512 for steak satisfied the user preference selections 280 for steak because the recommended steak reached a threshold fatty composition (e.g., fattiness level). User B may utilize the grocery delivery service and provide feedback that the recommended grocery items 512 for steak did not satisfy the user preference selections 280 for steak because the recommended steak did not meet a specific fatty composition (e.g., fattiness level). The one or more item recommendation models 502 may include an item recommendation model 502 for user A and an item recommendation model 502 for user B where the respective item recommendation models 502 are trained based on the feedback for the respective users 125. In some examples, the shopper device 131 may access an item recommendation model 502 that has been trained by feedback from the requesting user 125.

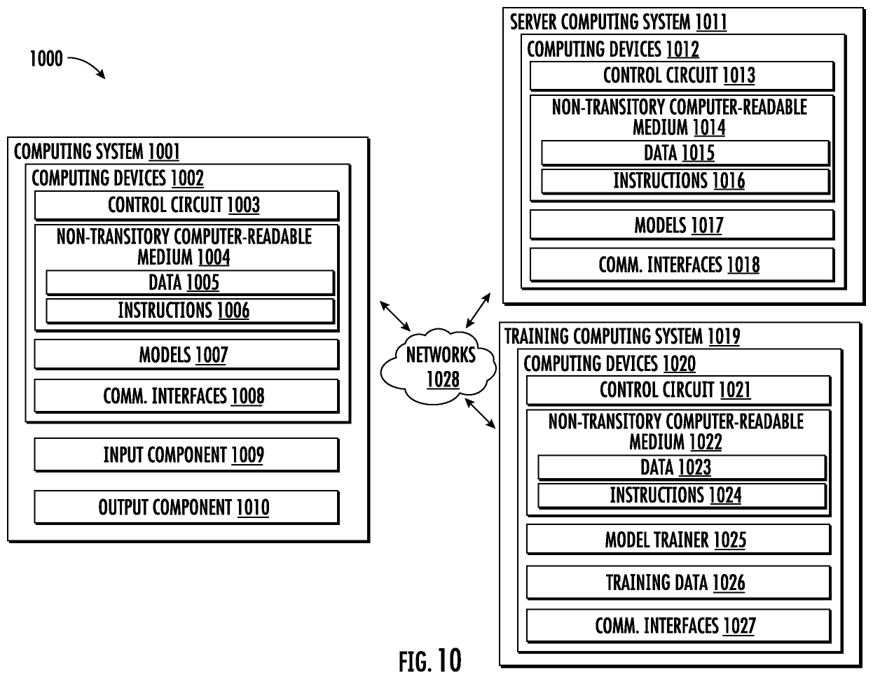

FIG. 10 depicts a block diagram of an example system 1000 for implementing systems and methods according to example embodiments of the present disclosure. The system 1000 includes a computing system 1001 (e.g., a shopper device 131 corresponding to a shopper 135), a server computing system 1011 (e.g., a network system 101, cloud computing platform), and a training computing system 1019 communicatively coupled over one or more networks 1028.

The computing system 1001 may include one or more computing devices 1002 or circuitry. For instance, the computing system 1001 may include a control circuit 1003 and a non-transitory computer-readable medium 1004, also referred to herein as memory. In an embodiment, the control circuit 1003 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In an embodiment, the control circuit 1003 may be programmed by one or more computer-readable or computer-executable instructions stored on the non-transitory computer-readable medium 1004.

In an embodiment, the non-transitory computer-readable medium 1004 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium 1004 may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The non-transitory computer-readable medium 1004 may store information that may be accessed by the control circuit 1003. For instance, the non-transitory computer-readable medium 1004 (e.g., memory devices) may store data 1005 that may be obtained, received, accessed, written, manipulated, created, and/or stored. The data 1005 may include, for instance, any of the data or information described herein. In some implementations, the computing system 1001 may obtain data from one or more memories that are remote from the computing system 1001.

The non-transitory computer-readable medium 1004 may also store computer-readable instructions 1006 that may be executed by the control circuit 1003. The instructions 1006 may be software written in any suitable programming language or may be implemented in hardware.

The instructions 1006 may be executed in logically and/or virtually separate threads on the control circuit 1003. For example, the non-transitory computer-readable medium 1004 may store instructions 1006 that when executed by the control circuit 1003 cause the control circuit 1003 to perform any of the operations, methods and/or processes described herein. In some cases, the non-transitory computer-readable medium 1004 may store computer-executable instructions or computer-readable instructions, such as instructions to perform at least a portion of the method of FIG. 9.

In an embodiment, the computing system 1001 may store or include one or more machine-learned models 1007. For example, the machine-learned models 1007 may be or may otherwise include various machine-learned models. In an embodiment, the machine-learned models 1007 may include neural networks (e.g., deep neural networks) or other types of machine-learned models, including non-linear models and/or linear models. Neural networks may include feed-forward neural networks, recurrent neural networks (e.g., long short-term memory recurrent neural networks), convolutional neural networks or other forms of neural networks. Some example machine-learned models may leverage an attention mechanism such as self-attention. For example, some example machine-learned models may include multi-headed self-attention models (e.g., transformer models).

In an embodiment, the one or more machine-learned models 1007 may be received from the server computing system 1011 over networks 1028, stored in the computing system 1001 (e.g., non-transitory computer-readable medium 1004), and then used or otherwise implemented by the control circuit 1003. In an embodiment, the computing system 1001 may implement multiple parallel instances of a single model.

Additionally, or alternatively, one or more machine-learned models 1007 may be included in or otherwise stored and implemented by the server computing system 1011 that communicates with the computing system 1001 according to a client-server relationship. For example, the machine-learned models 1007 may be implemented by the server computing system 1011 as a portion of a web service. Thus, one or more models 1007 may be stored and implemented at the computing system 1001 and/or one or more models 1007 may be stored and implemented at the server computing system 1011.

The computing system 1001 may include one or more communication interfaces 1008. The communication interfaces 1008 may be used to communicate with one or more other systems. The communication interfaces 1008 may include any circuits, components, software, etc. for communicating via one or more networks (e.g., networks 1028). In some implementations, the communication interfaces 1008 may include for example, one or more of a communications controller, receiver, transceiver, transmitter, port, conductors, software and/or hardware for communicating data/information.

The computing system 1001 may also include one or more user input components 1009 that receives user input. For example, the user input component 1009 may be a touch-sensitive component (e.g., a touch-sensitive user interface of a mobile device) that is sensitive to the touch of a user input object (e.g., a finger or a stylus). The touch-sensitive component may serve to implement a virtual keyboard. Other example user input components include a microphone, a traditional keyboard, cursor-device, joystick, or other devices by which a user may provide user input.

The computing system 1001 may include one or more output components 1010. The output components 1010 may include hardware and/or software for audibly or visually producing content. For instance, the output components 1010 may include one or more speakers, earpieces, headsets, handsets, etc. The output components 1010 may include a display device, which may include hardware for displaying a user interface and/or messages for a user. By way of example, the output component 1010 may include a display screen, CRT, LCD, plasma screen, touch screen, TV, projector, tablet, and/or other suitable display components.

The server computing system 1011 may include one or more computing devices 1012. In an embodiment, the server computing system 1011 may include or is otherwise implemented by one or more server computing devices. In instances in which the server computing system 1011 includes plural server computing devices, such server computing devices may operate according to sequential computing architectures, parallel computing architectures, or some combination thereof.

The server computing system 1011 may include a control circuit 1013 and a non-transitory computer-readable medium 1014, also referred to herein as memory 1014. In an embodiment, the control circuit 1013 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In an embodiment, the control circuit 1013 may be programmed by one or more computer-readable or computer-executable instructions stored on the non-transitory computer-readable medium 1014.

In an embodiment, the non-transitory computer-readable medium 1014 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The non-transitory computer-readable medium 1014 may store information that may be accessed by the control circuit 1013. For instance, the non-transitory computer-readable medium 1014 (e.g., memory devices) may store data 1015 that may be obtained, received, accessed, written, manipulated, created, and/or stored. The data 1015 may include, for instance, any of the data or information described herein. In some implementations, the server computing system 1011 may obtain data from one or more memories that are remote from the server computing system 1011.

The non-transitory computer-readable medium 1014 may also store computer-readable instructions 1016 that may be executed by the control circuit 1013. The instructions 1016 may be software written in any suitable programming language or may be implemented in hardware. The instructions may include computer-readable instructions, computer-executable instructions, etc.

The instructions 1016 may be executed in logically and/or virtually separate threads on the control circuit 1013. For example, the non-transitory computer-readable medium 1014 may store instructions 1016 that when executed by the control circuit 1013 cause the control circuit 1013 to perform any of the operations, methods and/or processes described herein. In some cases, the non-transitory computer-readable medium 1014 may store computer-executable instructions or computer-readable instructions, such as instructions to perform at least a portion of the methods of FIG. 9.

The server computing system 1011 may store or otherwise include one or more machine-learned models 1017. The machine-learned models 1017 may include or be the same as the models 1007 stored in computing system 1001. In an embodiment, the machine-learned models 1017 may include an unsupervised learning model. In an embodiment, the machine-learned models 1017 may include neural networks (e.g., deep neural networks) or other types of machine-learned models, including non-linear models and/or linear models. Neural networks may include feed-forward neural networks, recurrent neural networks (e.g., long short-term memory recurrent neural networks), convolutional neural networks or other forms of neural networks. Some example machine-learned models may leverage an attention mechanism such as self-attention. For example, some example machine-learned models may include multi-headed self-attention models (e.g., transformer models).

The machine-learned models described in this specification may have various types of input data and/or combinations thereof, representing data available to sensors and/or other systems onboard a vehicle. Input data may include, for example, latent encoding data (e.g., a latent space representation of an input, etc.), statistical data (e.g., data computed and/or calculated from some other data source), sensor data (e.g., raw and/or processed data captured by a sensor of the vehicle), or other types of data.

The server computing system 1011 may include one or more communication interfaces 1018. The communication interfaces 1018 may be used to communicate with one or more other systems. The communication interfaces 1018 may include any circuits, components, software, etc. for communicating via one or more networks (e.g., networks 1028). In some implementations, the communication interfaces 1018 may include for example, one or more of a communications controller, receiver, transceiver, transmitter, port, conductors, software and/or hardware for communicating data/information.

The computing system 1001 and/or the server computing system 1011 may train the models 1007, 1017 via interaction with the training computing system 1019 that is communicatively coupled over the networks 1028. The training computing system 1019 may be separate from the server computing system 1011 or may be a portion of the server computing system 1011.

The training computing system 1019 may include one or more computing devices 1020. In an embodiment, the training computing system 1019 may include or is otherwise implemented by one or more server computing devices. In instances in which the training computing system 1019 includes plural server computing devices, such server computing devices may operate according to sequential computing architectures, parallel computing architectures, or some combination thereof.

The training computing system 1019 may include a control circuit 1021 and a non-transitory computer-readable medium 1022, also referred to herein as memory 1022. In an embodiment, the control circuit 1021 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In an embodiment, the control circuit 1021 may be programmed by one or more computer-readable or computer-executable instructions stored on the non-transitory computer-readable medium 1022.

In an embodiment, the non-transitory computer-readable medium 1022 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The non-transitory computer-readable medium 1022 may store information that may be accessed by the control circuit 1021. For instance, the non-transitory computer-readable medium 1022 (e.g., memory devices) may store data 1023 that may be obtained, received, accessed, written, manipulated, created, and/or stored. The data 1023 may include, for instance, any of the data or information described herein. In some implementations, the training computing system 1019 may obtain data from one or more memories that are remote from the training computing system 1019.

The non-transitory computer-readable medium 1022 may also store computer-readable instructions 1024 that may be executed by the control circuit 1021. The instructions 1024 may be software written in any suitable programming language or may be implemented in hardware. The instructions may include computer-readable instructions, computer-executable instructions, etc.

The instructions 1024 may be executed in logically or virtually separate threads on the control circuit 1021. For example, the non-transitory computer-readable medium 1022 may store instructions 1024 that when executed by the control circuit 1021 cause the control circuit 1021 to perform any of the operations, methods and/or processes described herein. In some cases, the non-transitory computer-readable medium 1022 may store computer-executable instructions or computer-readable instructions, such as instructions to perform at least a portion of the methods of FIG. 9.

The training computing system 1019 may include a model trainer 1025 that trains the machine-learned models 1007, 1017 stored at the computing system 1001 and/or the server computing system 1011 using various training or learning techniques. For example, the models 1007, 1017 may be trained using a loss function. By way of example, for training a machine-learned segmentation or recommendation model, the model trainer 1025 may use a loss function. For example, a loss function can be backpropagated through the model(s) 1007, 1017 to update one or more parameters of the model(s) 1007, 1017 (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

The model trainer 1025 may train the models 1007, 1017 (e.g., a machine-learned clustering model) in an unsupervised fashion. As such, the models 1007, 1017 may be effectively trained using unlabeled data for particular applications or problem domains, which improves performance and adaptability of the models 1007, 1017.

The training computing system 1019 may modify parameters of the models 1007, 1017 (e.g., the machine-learned models 501, 502) based on the loss function such that the models 1007, 1017 may be effectively trained for specific applications in an unsupervised manner without labeled data.

The model trainer 1025 may utilize training techniques, such as backwards propagation of errors. For example, a loss function may be backpropagated through a model to update one or more parameters of the models (e.g., based on a gradient of the loss function). Various loss functions may be used such as mean squared error, likelihood loss, cross entropy loss, hinge loss, and/or various other loss functions. Gradient descent techniques may be used to iteratively update the parameters over a number of training iterations.

In an embodiment, performing backwards propagation of errors may include performing truncated backpropagation through time. The model trainer 1025 may perform a number of generalization techniques (e.g., weight decays, dropouts, etc.) to improve the generalization capability of a model being trained. In particular, the model trainer 1025 may train the machine-learned models 1007, 1017 based on a set of training data 1026.

The training data 1026 may include unlabeled training data for training in an unsupervised fashion. In an example, the training data 1026 may include unlabeled sets of data indicative of varying degrees of ripeness for produce grocery items and data indicative of confirmed ripeness (e.g., unripe, ripe, over ripe), for a produce grocery items. The training data 1026 may be specific to a grocery item to help focus the models 1007, 1017 on the particular grocery item.

In an embodiment, training examples may be provided by the computing system 1001 (e.g., mobile device of the shopper). Thus, in such implementations, a model 1007 provided to the computing system 1001 may be trained by the training computing system 1019 in a manner to personalize the model 1007.

The model trainer 1025 may include computer logic utilized to provide desired functionality. The model trainer 1025 may be implemented in hardware, firmware, and/or software controlling a general-purpose processor. For example, in an embodiment, the model trainer 1025 may include program files stored on a storage device, loaded into a memory and executed by one or more processors. In other implementations, the model trainer 1025 may include one or more sets of computer-executable instructions that are stored in a tangible computer-readable storage medium such as RAM, hard disk, or optical or magnetic media.

The training computing system 1019 may include one or more communication interfaces 1027. The communication interfaces 1027 may be used to communicate with one or more other systems. The communication interfaces 1027 may include any circuits, components, software, etc. for communicating via one or more networks (e.g., networks 1028). In some implementations, the communication interfaces 1027 may include for example, one or more of a communications controller, receiver, transceiver, transmitter, port, conductors, software and/or hardware for communicating data/information.

The one or more networks 1028 may be any type of communications network, such as a local area network (e.g., intranet), wide area network (e.g., Internet), or some combination thereof and may include any number of wired or wireless links. In general, communication over a network 1028 may be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 10 illustrates one example computing system that may be used to implement the present disclosure. Other computing systems may be used as well. For example, in an embodiment, the computing system 1001 may include the model trainer 1025 and the training data 1026. In such implementations, the models 1007, 1017 may be both trained and used locally at the computing system 1001. In some of such implementations, the computing system 1001 may implement the model trainer 1025 to personalize the models 1007, 1017.

Computing tasks discussed herein as being performed at certain computing device(s)/systems may instead be performed at another computing device/system, or vice versa. Such configurations may be implemented without deviating from the scope of the present disclosure. The use of computer-based systems allows for a great variety of possible configurations, combinations, and divisions of tasks and functionality between and among components. Computer-implemented operations may be performed on a single component or across multiple components. Computer-implemented tasks or operations may be performed sequentially or in parallel. Data and instructions may be stored in a single memory device or across multiple memory devices.

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein may be implemented using a single device or component or multiple devices or components working in combination. Databases and applications may be implemented on a single system or distributed across multiple systems. Distributed components may operate sequentially or in parallel.

Aspects of the disclosure have been described in terms of illustrative implementations thereof. Numerous other implementations, modifications, or variations within the scope and spirit of the appended claims may occur to persons of ordinary skill in the art from a review of this disclosure. Any and all features in the following claims may be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. The term “or” and “and/or” may be used interchangeably herein. Lists joined by a particular conjunction such as “or,” for example, may refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims discussed herein may be adapted, rearranged, expanded, omitted, combined, or modified in various ways without deviating from the scope of the present disclosure. Some implementations are described with a reference numeral for example illustrated purposes and are not meant to be limiting.

What is claimed is:

1. A computer-implemented method comprising:
accessing, by a mobile user device, data indicative of a requested grocery item, wherein the requested grocery item is included in a delivery request for a user, and wherein the requested grocery item is presented on a user interface of the mobile user device;
accessing, by the mobile user device, data indicative of a preference of the user associated with the requested grocery item;
obtaining, via one or more sensors of the mobile user device, sensor data indicative of a plurality of grocery items currently available for selection at a merchant location;
determining, by the mobile user device and using one or more machine-learned models, a recommended grocery item from the plurality of grocery items currently available at the merchant location for selection based on the data indicative of the preference of the user associated with the requested grocery item, wherein the one or more machine-learned models are trained to:
obtain input data that is based on the preference of the user associated with the requested grocery item and the sensor data indicative of the plurality of grocery items currently available for selection at the merchant location,
compute the recommended grocery item from the plurality of grocery items currently available at the merchant location for selection based on the preference of the user, and
output data indicative of the recommended grocery item from the plurality of grocery items currently available at the merchant location; and
outputting, by the mobile user device and based on a selection of the recommended grocery item for the requested grocery item, a command instruction to generate an updated user interface that indicates the requested grocery item has been addressed.

2. The computer-implemented method of claim 1, wherein the one or more machine-learned models are trained to:
obtain a previous delivery request for the requested grocery item, wherein the previous delivery request for the requested grocery item indicates a previous preference of the user; and
determine the preference of the user based on the previous delivery request for the requested grocery item.

3. The computer-implemented method of claim 1, wherein the one or more machine-learned models are trained to compute the recommended grocery item by:
identifying a grocery item from the plurality of grocery items currently available at the merchant location, wherein the identified grocery item is indicative of an individual or grouping of grocery items;
analyzing the identified grocery item to determine characteristics, wherein the characteristics are associated with the preference of the user; and
determining the recommended grocery item based on the characteristics of the grocery item.

4. The computer-implemented method of claim 1, further comprising:
obtaining, via the one or more sensors of the mobile user device, second sensor data, wherein the second sensor data is indicative of the recommended grocery item; and
determining, by the mobile user device and using the one or more machine-learned models, the recommended grocery item based on the second sensor data and the preference of the user.

5. The computer-implemented method of claim 1, further comprising:
accessing, by the mobile user device, data indicative of the one or more machine-learned models based on a type of the requested grocery item.

6. The computer-implemented method of claim 1, further comprising:
accessing, by the mobile user device, data indicative of the one or more machine-learned models based on the user associated with the requested grocery item.

7. The computer-implemented method of claim 1, wherein the one or more machine-learned models are retrained based on feedback data from the user, wherein the feedback data is indicative of a satisfaction of the user with the recommended grocery item.

8. The computer-implemented method of claim 1, wherein the preference of the user associated with the requested grocery item is indicative of at least one of: (i) a ripeness level; or (ii) a fattiness level.

9. The computer-implemented method of claim 1, further comprising:
generating, by the mobile user device and based on the selection of the recommended grocery item for the requested grocery item, the updated user interface that indicates the requested grocery item has been addressed.

10. The computer-implemented method of claim 1, further comprising:
determining, by the mobile user device, that the requested grocery item is not currently available at the merchant location; and
wherein the recommended grocery item is a replacement item for the requested grocery item.

11. The computer-implemented method of claim 1, wherein the data indicative of the preference of the user is generated based on user input provided by the user during formation of a delivery request.

12. The computer-implemented method of claim 1, wherein the data indicative of the preference of the user is accessed via a data structure stored in a memory, the data structure storing preference data associated with the user over a plurality of delivery request instances.

13. The computer-implemented method of claim 1, wherein the one or more machine-learned models comprises:
an item detection model and an item recommendation model wherein:
the item detection model is trained to receive the sensor data indicative of the plurality of grocery items currently available for selection at the merchant, and in response to receipt of the sensor data, generate grocery item data comprising at least: (i) a type of the grocery items; and (ii) a quantity of grocery items of the plurality of grocery items; and
the item recommendation model is trained to receive the grocery item data and the input data based on the preference of the user, and in response to receipt of the grocery item data and input data, determine the recommended grocery item from the plurality of grocery items.

14. A computing system comprising:
one or more processors; and
one or more non-transitory, computer-readable media storing instructions that are executable by the one or more processors to cause the computing system to perform operations, the operations comprising:
accessing data indicative of a requested grocery item, wherein the requested grocery item is included in a delivery request for a user, and wherein the requested grocery item is presented on a user interface of a mobile user device;
accessing data indicative of a preference of the user associated with the requested grocery item;
obtaining, via one or more sensors of the mobile user device, sensor data indicative of a plurality of grocery items currently available for selection at a merchant location;
determining, using one or more machine-learned models, a recommended grocery item from the plurality of grocery items currently available at the merchant location for selection based on the data indicative of the preference of the user associated with the requested grocery item, wherein the one or more machine-learned models are trained to:
obtain input data that is based on the preference of the user associated with the requested grocery item and the sensor data indicative of the plurality of grocery items currently available for selection at the merchant location,
compute the recommended grocery item from the plurality of grocery items currently available at the merchant location for selection based on the preference of the user, and
output data indicative of the recommended grocery item from the plurality of grocery items currently available at the merchant location; and
outputting, based on a selection of the recommended grocery item for the requested grocery item, a command instruction to generate an updated user interface that indicates the requested grocery item has been addressed.

15. The computing system of claim 14, wherein the one or more machine-learned models are trained to:
obtain a previous delivery request for the requested grocery item, wherein the previous delivery request for the requested grocery item indicates a previous preference of the user; and
determine the preference of the user based on the previous delivery request for the requested grocery item.

16. The computing system of claim 14, further comprising:
obtaining, via the one or more sensors of the mobile user device, second sensor data, wherein the second sensor data is indicative of the recommended grocery item; and
determining, using the one or more machine-learned models, the recommended grocery item based on the second sensor data and the preference of the user.

17. The computing system of claim 14, further comprising:
accessing data indicative of the one or more machine-learned models based on a type of the requested grocery item.

18. The computer-implemented method of claim 14, further comprising:
accessing data indicative of the one or more machine-learned models based on the user associated with the requested grocery item.

19. The computing system of claim 14, wherein the one or more machine-learned models are retrained based on feedback data from the user, wherein the feedback data is indicative of a satisfaction of the user with the recommended grocery item.

20. One or more non-transitory computer-readable media storing instructions that are executable to cause one or more processors to perform operations, the operations comprising:
accessing, by a mobile user device, data indicative of a requested grocery item, wherein the requested grocery item is included in a delivery request for a user, and wherein the requested grocery item is presented on a user interface of the mobile user device;
accessing, by the mobile user device, data indicative of a preference of the user associated with the requested grocery item;
obtaining, via one or more sensors of the mobile user device, sensor data indicative of a plurality of grocery items currently available for selection at a merchant location;
determining, by the mobile user device and using one or more machine-learned models, a recommended grocery item from the plurality of grocery items currently available at the merchant location for selection based on the data indicative of the preference of the user associated with the requested grocery item, wherein the one or more machine-learned models are trained to:
obtain input data that is based on the preference of the user associated with the requested grocery item and the sensor data indicative of the plurality of grocery items currently available for selection at the merchant location,
compute the recommended grocery item from the plurality of grocery items currently available at the merchant location for selection based on the preference of the user, and
output data indicative of the recommended grocery item from the plurality of grocery items currently available at the merchant location; and
outputting, by the mobile user device and based on a selection of the recommended grocery item for the requested grocery item, a command instruction to generate an updated user interface that indicates the requested grocery item has been addressed.
